(19) United States
(12) Patent Application Publication
(10) Pub. No.: US 2026/0100045 A1
(43) Pub. Date: Apr. 9, 2026

(54) IMAGE PROCESSING DEVICE, IMAGE PROCESSING METHOD, AND RECORDING MEDIUM

(71) Applicant: Sony Semiconductor Solutions Corporation, Kanagawa (JP)

(72) Inventor: Izumu HOSOI, Kanagawa (JP)

(73) Assignee: Sony Semiconductor Solutions Corporation, Kanagawa (JP)

(21) Appl. No.: 19/116,386

(22) PCT Filed: Sep. 20, 2023
(86) PCT No.: PCT/JP2023/034009

§ 371 Date: Mar. 28, 2025

(30) Foreign Application Priority Data
Oct. 18, 2022 (JP) 2022-166884

(51) Int. Cl. G06V 20/52; G06F 21/62; G06T 11/00; G06V 10/25; G06V 10/764; G06V 10/778

(52) U.S. Cl. CPC G06V 20/52; G06F 21/6254; G06T 11/00; G06V 10/25; G06V 10/764; G06V 10/778

(57) ABSTRACT

An image processing device includes circuitry that recognizes and extracts an object included in a captured image, and that converts, using an artificial intelligence (AI) model, a region image including the object to generate a feature image. The circuitry generates a mask image by combining the captured image with the feature image.

### CROSS REFERENCE TO RELATED APPLICATIONS

This application claims the benefit of Japanese Priority Patent Application JP 2022-166884 filed on Oct. 18, 2022, the entire contents of each which are incorporated herein by reference.

### TECHNICAL FIELD

The present disclosure relates to an image processing device and an image processing method that generate an image having been subjected to processing for making it difficult to specify information for identifying a subject, and a recording medium storing a program for generating an image having been subjected to processing for making it difficult to specify information for identifying a subject.

### BACKGROUND ART

In recent years, surveillance cameras have been used for various purposes such as monitoring of a child at home, prevention of patient misidentification in a medical setting, and tracking of a suspect's vehicle fleeing on the roads. Meanwhile, as importance of personal information protection increases, anonymization of data obtained by surveillance cameras is demanded. Anonymization techniques have been disclosed in PTLs 1 and 2, for example.

### CITATION LIST

### Patent Literature

PTL 1: Japanese Unexamined Patent Application Publication No. 2020-174336

PTL 2: Japanese Unexamined Patent Application Publication No. 2021-128499

### SUMMARY

### Technical Problem

In the techniques described in PTLs 1 and 2, a face is anonymized, and a person as a subject is recognized on the basis of features (e.g., pulses and clothes) other than the face. However, in such a case, there is an issue that a primary function (subject recognition function) as a surveillance camera is impaired. It is therefore desirable to provide an image processing device and an image processing method that make it possible to perform processing for making it difficult to specify information for identifying a subject without impairing a subject recognition function, and a recording medium storing a program that makes it possible to perform processing for making it difficult to specify information for identifying a subject without impairing a subject recognition function.

### Solution to Problem

An image processing device according to a first aspect of the present disclosure includes circuitry configured to recognize and extract an object included in a captured image. The circuitry is also configured to convert, based on an artificial intelligence (AI) mode, a region image including the object to generate a feature image. The circuitry is further configured to generate a mask image by combining the captured image with the feature image, and to output the mask image.

An image processing method according to a second aspect of the present disclosure includes recognizing and extracting an object included in a captured image; converting, using an artificial intelligence (AI) model, a region image including the object to generate a feature image; generating a mask image by combining the captured image with the generated feature image; and outputting the mask image.

A non-transitory computer-readable recording medium according to a third aspect of the present disclosure stores a program that, when executed by a computer, causes the computer to perform a method including recognizing and extracting an object included in a captured image; converting, based on an artificial intelligence (AI) mode, a region image including the object to generate a feature image; generating a mask image by combining the captured image with the generated feature image; and outputting the mask image.

### BRIEF DESCRIPTION OF DRAWINGS

FIG. 1 is a diagram illustrating a schematic configuration example of an anonymization surveillance camera according to an embodiment of the present disclosure.

FIG. 2 is a diagram illustrating a schematic configuration example of an AI model for generating an AI model when configuring a feature amount converter with the AI model.

FIG. 3 is a diagram illustrating a modification example of a schematic configuration of the anonymization surveillance camera in FIG. 1.

FIG. 4 is a diagram illustrating a schematic configuration example of an information processing device that processes a mask image outputted from the anonymization surveillance camera in FIG. 1.

FIG. 5 is a diagram illustrating an example of a processing procedure in the anonymization surveillance camera in FIG. 1.

FIG. 6 is a diagram illustrating a schematic configuration example of an information processing system including a modification example of a schematic configuration of the anonymization surveillance camera in FIG. 1.

FIG. 7 is a diagram illustrating a configuration example of an information processing system.

FIG. 8 is a diagram for describing respective devices that perform registration and downloading of an AI model and an AI application through a market place function included in a cloud-side information processing device.

FIG. 9 is a diagram illustrating, together with FIG. 10, an example of a processing flow to be executed by respective devices when performing registration and downloading of the AI model and the AI application through the market place function.

FIG. 10 is a diagram illustrating, together with FIG. 9, the example of the processing flow to be executed by respective devices when performing registration and downloading of the AI model and the AI application through the market place function.

FIG. 11 is a diagram for describing a coupling mode of the cloud-side information processing device and an edge-side information processing device.

FIG. 12 is a functional block diagram of the cloud-side information processing device.

FIG. 13 is a block diagram illustrating an internal configuration example of a camera.

FIG. 14 is a diagram illustrating a configuration example of an image sensor.

FIG. 15 is a block diagram illustrating a software configuration of the camera.

FIG. 16 is a block diagram illustrating an operation environment of a container in a case where a container technology is used.

FIG. 17 is a block diagram illustrating an example of a hardware configuration of an information processing device.

FIG. 18 is a diagram for describing a processing flow in another description.

FIG. 19 is a diagram illustrating an example of a login screen for logging in to a market place.

FIG. 20 is a diagram illustrating an example of a developer screen presented to each developer who uses the market place.

FIG. 21 is a diagram illustrating an example of a user screen presented to an application user who uses the market place.

FIG. 22 is a block diagram depicting an example of schematic configuration of a vehicle control system.

FIG. 23 is a diagram of assistance in explaining an example of installation positions of an outside-vehicle information detecting section and an imaging section.

### DESCRIPTION OF EMBODIMENTS

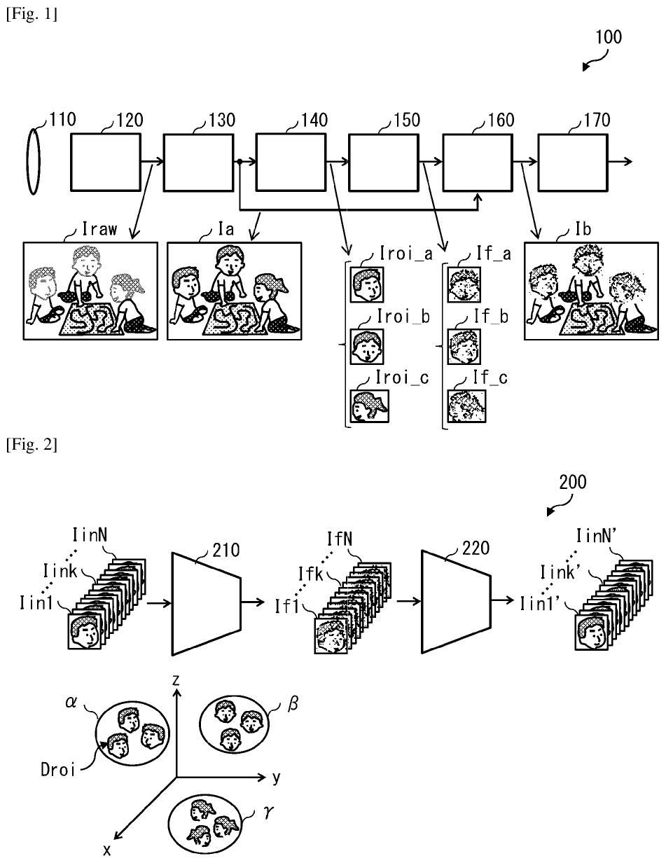

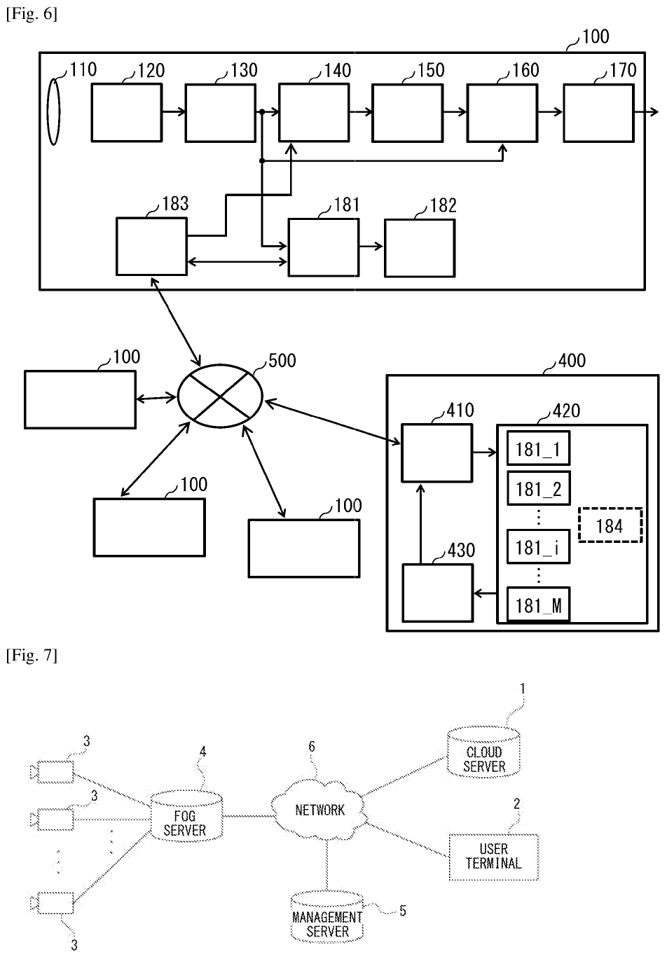

In the following, some embodiments of the present disclosure are described in detail with reference to the drawings. It is to be noted that description is given in the following order.
1. Embodiment (FIGS. 1 to 5)
2. Modification Example (FIG. 6)
3. Application Examples (FIGS. 7 to 23)

### 1. Embodiment

### Configuration

Description is given of an anonymization surveillance camera 100 according to an embodiment of the present disclosure. FIG. 1 illustrates a schematic configuration example of the anonymization surveillance camera 100. The anonymization surveillance camera 100 includes, for example, a lens 110, an imaging section 120, a development section 130, a subject recognition section 140, a feature amount converter 150, a mask processor 160, and an output section 170, as illustrated in FIG. 1.

The lens 110 includes one or more lenses, and guides light (incident light) from a subject to the imaging section 120, and forms an image of the light on a light-receiving surface of the imaging section 120.

The imaging section 120 periodically accumulates signal charge in response to the light of which the image is formed on the light-receiving surface through the lens 110. The signal charge accumulated in the imaging section 120 is transferred as a pixel signal (image data) to a DSP circuit in the imaging section 120. In other words, the imaging section 120 receives image light (incident light) incident through the lens 110, and outputs the pixel signal corresponding to the received image light (incident light) to the DSP circuit. The DSP circuit includes a signal processing circuit that processes the pixel signal (image data). The imaging section 120 temporarily holds the image data processed by the DSP circuit in frame units in a frame memory. The imaging section 120 outputs image data read from the frame memory as RAW image data Iraw to the development section 130.

The development section 130 performs processing for easing imaging environment dependence of the RAW image data Iraw so as to allow the subject recognition section 140 in a subsequent stage to perform processing. The development section 130 performs, for example, demosaicing, a linear matrix operation, gamma correction, or the like corresponding to an imaging environment, on the RAW image data Iraw. The development section 130 outputs image data Ia obtained by the processing described above to the subject recognition section 140.

The subject recognition section 140 recognizes and extracts the subject, or an object, included in the image data Ia. The subject is not specifically limited, and examples of the subject include a human face and a vehicle. The subject recognition section 140 extracts an image of a target region including the subject included in the image data Ia, and outputs the extracted image as ROI image data Iroi to the feature amount converter 150. FIG. 1 exemplifies a state in which the subject recognition section 140 outputs three pieces of ROI image data Iroi_a, Iroi_b, and Iroi_c obtained from the image data Ia.

The subject recognition section 140 includes, for example, an AI (artificial intelligence) model. This AI model is, for example, a model specialized for extraction of a specific subject. In a case where image data obtained in a specific imaging environment suitable for extraction of a specific subject is inputted, the AI model extracts the specific subject included in the inputted image data. This AI model is a model obtained by learning a master image as an input image (that is, a general purpose model). The master image is obtained in the specific imaging environment suitable for extraction of the specific subject.

The feature amount converter 150 encodes a region image (ROI image data Iroi) including the subject obtained by extraction in the subject recognition section 140 to generate feature amount image data If. The feature amount converter 150 outputs the generated feature amount image data If to the mask processor 160. FIG. 1 exemplifies a state in which the feature amount converter 150 outputs three pieces of generated feature amount image data If_a, If_b, and If_c.

The feature amount converter 150 projects the ROI image data Iroi to an M-dimensional feature amount space, and dimensionally compresses feature amount data Droi obtained by projection to generate the feature amount image data If. The feature amount converter 150 includes, for example, an AI model that outputs the feature amount image data If in response to inputting the ROI image data Iroi.

FIG. 2 illustrates a schematic configuration example of an AI model 200 for generating an AI model when configuring the feature amount converter 150 with the AI model. The AI model 200 includes, for example, an encoder 210 and a decoder 220, as illustrated in FIG. 2.

The encoder 210 is a first AI model that encodes an input image to generate a feature amount image. The decoder 220 is a second AI model that decodes the feature amount image generated by the first AI model to generate an output image. In a case where N input images Iin1 to IinN are sequentially inputted to the first AI model during learning, N pieces of feature amount image data If1 to IfN are sequentially outputted from the first AI model. In a case where the N pieces of feature amount image data If1 to IfN outputted from the first AI model are sequentially inputted to the second AI model, N pieces of output images Iin1′ to IinN′ are sequentially outputted from the second AI model. The first AI model and the second AI model are models having been subjected to learning to cause an output image Iink′ (1≤k≤N) outputted from the second AI model to further approximate to an input image Iink inputted to the first AI model. The feature amount converter 150 includes the first AI model in the AI model 200 having been subjected to learning as described above.

The feature amount image data If herein is an image including the subject that is difficult to be visually identified. Accordingly, the feature amount image data If is meaningless as information for identifying the subject. Meanwhile, using the second AI model described above makes it possible to obtain an image (output image Iink′) approximating to the input image Iink from the feature amount image data If. Accordingly, concealing the second AI model described above from a user of a mask image Ib (to be described later) including the feature amount image data If makes it possible to prevent the information for identifying the subject from being leaked to outside. In addition, the output image Iink′ does not become exactly the same as the input image Iink; therefore, it can be said that the first AI model described above is a model that performs irreversible conversion.

Note that M-dimensional feature amount data obtained by decoding the feature amount image data If by a publicly known decoder (e.g., a decoding section 330 to be described later) has a feature specific to the subject. Accordingly, for example, in a case where M-dimensional feature amount data obtained from the feature amount image data If at a time t1 and M-dimensional feature amount data obtained from the feature amount image data If at a time t2 have values that are the same as or similar to each other, a subject corresponding to the feature amount image data If at the time t1 is presumed to be identical to a subject corresponding to the feature amount image data If at the time t2. Thus, the feature amount image data If includes an image that allows for identification of the subject by decoding while preventing the information for identifying the subject from being leaked to outside.

The mask processor 160 generates the mask image Ib by combining the image data Ia and the feature amount image data If with each other. The mask processor 160 generates the mask image Ib, for example, by superimposing the feature amount image data If on a region corresponding to the ROI image data Iroi of the image data Ia.

The output section 170 outputs the mask image Ib in a predetermined data formant to outside.

Incidentally, for example, as illustrated in FIG. 3, it is possible to implement functions of the development section 130, the subject recognition section 140, the feature amount converter 150, and the mask processor 160 by loading an image processing program 192a stored in the storage section 192 into the image processor 191. In this case, the storage section 192 includes, for example, a volatile memory such as a DRAM (Dynamic Random Access Memory) or a nonvolatile memory such as an EEPROM (Electrically Erasable Programmable Read-Only Memory) or a flash memory. The storage section 192 stores, for example, the image processing program 192a that causes the image processor 191 to execute processing that is to be executed by the development section 130, the subject recognition section 140, the feature amount converter 150, and the mask processor 160. The image processor 191 includes, for example, an operation device such as CPU (Central Processing Unit).

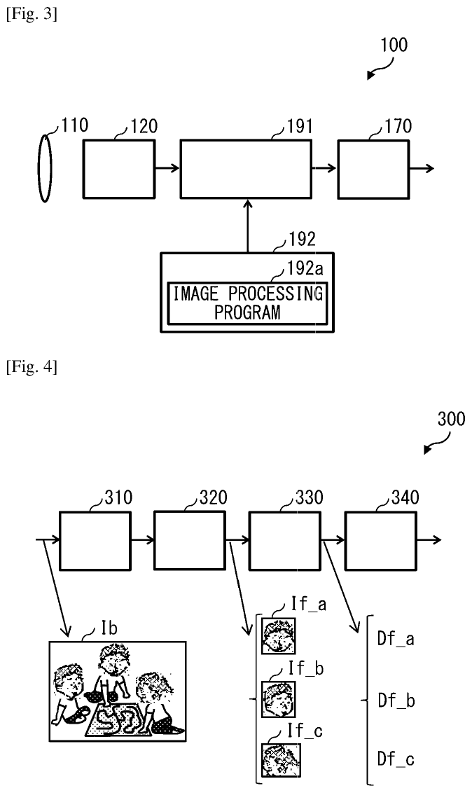

FIG. 4 illustrates a schematic configuration example of an information processing device 300 that processes the mask image Ib outputted from the anonymization surveillance camera 100. The information processing device 300 includes, for example, an image receiver 310, a subject recognition section 320, a decoding section 330, and an output section 340, as illustrated in FIG. 4.

The image receiver 310 includes an interface that receives the mask image Ib from the anonymization surveillance camera 100. The image receiver 310 outputs the mask image Ib to the subject recognition section 320. The subject recognition section 320 recognizes and extracts a subject included in the mask image Ib. The subject is not specifically limited, and examples of the subject include a human face and a vehicle.

The subject recognition section 320 extracts the feature amount image data If included in the mask image Ib, and outputs the extracted image (feature amount image data If) to the decoding section 330. FIG. 4 exemplifies a state in which the subject recognition section 320 outputs three pieces of feature amount image data If_a, If_b, and If_c obtained from the mask image Ib.

The subject recognition section 320 includes, for example, an AI model. This AI model is, for example, a model specialized for extraction of the feature amount image data If. In a case where the mask image Ib is inputted, the AI model extracts the feature amount image data If included in the inputted mask image Ib. This AI model is a model obtained by learning a feature amount image as an input image.

The decoding section 330 projects the feature amount image data If to the M-dimensional feature amount space, and outputs the feature amount data Df obtained by projection to the output section 340. FIG. 4 exemplifies a state in which the decoding section 330 outputs three pieces of feature amount data Df_a, Df_b, and Df_c obtained from the three pieces of feature amount image data If_a, If_b, and If_c.

The output section 340 outputs the feature amount data Df in a predetermined data format to outside.

It is to be noted that the image receiver 310 may include an interface that receives position data of the feature amount image data If included in the mask image Ib together with the mask image Ib. In this case, the subject recognition section 320 may extract the feature amount image data If included in the mask image Ib on the basis of, for example, the position data described above.

### Image Processing

Next, description is given of image processing in the anonymization surveillance camera 100.

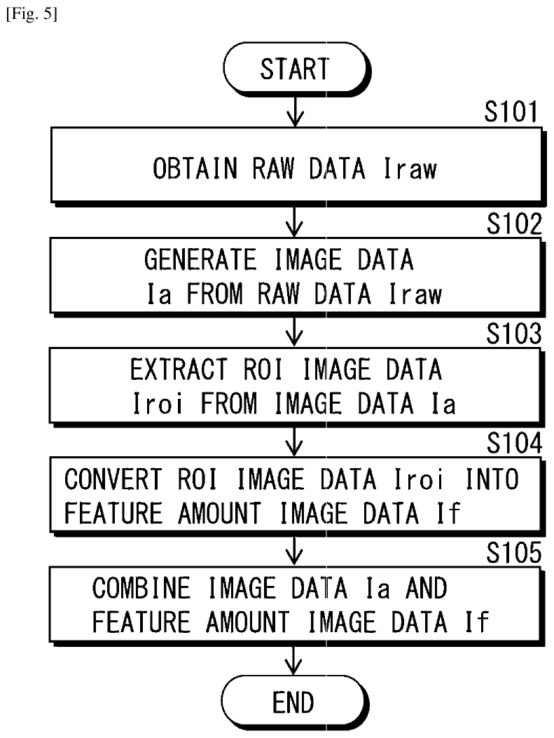

FIG. 5 illustrates an example of a processing procedure in the anonymization surveillance camera 100. First, the imaging section 120 obtains the RAW image data Iraw (step S101). Next, the development section 130 performs processing for easing the imaging environment dependence of the RAW image data Iraw so as to allow the subject recognition section 140 to perform processing, thereby generating the image data Ia (step S102).

Next, the subject recognition section 140 recognizes and extracts the subject included in the image data Ia. Accordingly, the subject recognition section 140 extracts the ROI image data Iroi from the image data Ia (step S103). Next, the feature amount converter 150 converts the ROI image data Iroi into the feature amount image data If (step S104). Specifically, the feature amount converter 150 encodes the ROI image data Iroi to generate the feature amount image data If.

The mask processor 160 generates the mask image Ib by combining the image data Ia and the feature amount image data If with each other (step S105). The output section 170 outputs the mask image Ib in a predetermined data format to outside. Thus, image processing in the anonymization surveillance camera 100 is executed.

### Effects

Next, description is given of effects of the anonymization surveillance camera 100.

In the present embodiment, the region image (ROI image data Iroi) that includes the subject and is extracted from the image data Ia is encoded to generate the feature amount image data If, and the mask image Ib is generated by combining the image data Ia and the feature amount image data If with each other. Herein, the feature amount image data If included in the mask image Ib is meaningless as the information for identifying the subject. Accordingly, it is not possible to obtain the information for identifying the subject from the mask image Ib, which makes it possible to prevent the information for identifying the subject from being leaked to outside even in a case where the mask image Ib is provided to outside. In addition, the M-dimensional feature amount data obtained by decoding the feature amount image data If by a publicly known decoder has a feature specific to the subject. Accordingly, it is possible to identify the subject by analyzing the M-dimensional feature amount data obtained from the feature amount image data If. Thus, it is possible to perform processing for making it difficult to specify the information for identifying the subject without impairing the subject recognition function.

In the present embodiment, the ROI image data Iroi is projected to a feature amount space, and the feature amount data obtained by projection is dimensionally compressed to generate the feature amount image data If. Herein, the M-dimensional feature amount data obtained by decoding the feature amount image data If by a publicly known decoder has a feature specific to the subject. Accordingly, it is possible to identify the subject by analyzing the M-dimensional feature amount data obtained from the feature amount image data If. Thus, it is possible to perform processing for making it difficult to specify the information for identifying the subject without impairing the subject recognition function.

In the present embodiment, the feature amount image data If is generated with use of the first AI model in the AI model 200 having been subjected to learning as described above. Thus, it is possible to perform processing for making it difficult to specify the information for identifying the subject without impairing the subject recognition function.

In the present embodiment, the feature amount image data If is an image including the subject that is difficult to be visually identified. Thus, it is possible to perform processing for making it difficult to specify the information for identifying the subject without impairing the subject recognition function.

In the present embodiment, processing for easing the imaging environment dependence of the RAW image data Iraw is performed to generate the image data Ia that is to be inputted to the subject recognition section 320. This makes it possible to efficiently extract the subject from the image data Ia. In addition, it is possible to configure the subject recognition section 320 with an Al model (that is, a general purpose model) obtained by learning, as an input image, a master image obtained in a specific imaging environment, which makes it possible to implement the anonymization surveillance camera 100 at low cost.

### 2. Modification Example

Next, description is given of a modification example of the anonymization surveillance camera 100 according to the embodiment described above. FIG. 6 illustrates a state in which a plurality of anonymization surveillance cameras 100 according to the present modification example, and an information processing device 400 are coupled to a network 500. Examples of the network 500 include the Internet, a cloud network, and a company-specific network.

The anonymization surveillance camera 100 according to the present modification example corresponds to the anonymization surveillance camera 100 according to the embodiment described above that further includes a subject recognition AI 181, a MLP (Multilayer perceptron) 182, and a communication section 183.

The subject recognition AI 181 is a model common to an AI model used in the subject recognition section 140. The AI model used in the subject recognition section 140 is an AI model with a fixed weight. In contrast, the subject recognition AI 181 is an AI model with a weight that is not fixed.

The MLP 182 is one classification of feedforward neural network, and includes at least three node layers. In the MLP 182, each of a plurality of node layers other than an input node layer is a neuron using a nonlinear activation function. The MLP 182 uses a supervised learning technique called backpropagation for learning.

The communication section 183 transmits the subject recognition AI 181 to the information processing device 400 through the network 500 at regular intervals. The subject recognition AI 181 does not include the information for identifying the subject. This makes it possible to prevent the information for identifying the subject from being leaked to outside even in a case where the subject recognition AI 181 is transmitted to the information processing device 400.

The information processing device 400 includes a communication section 410, a storage section 420, and a controller 430. The communication section 410 includes an interface that is able to communicate with the anonymization surveillance cameras 100 through the network 500.

The storage section 420 stores a plurality of subject recognition AIs 181 (181_1, 181_2, . . . , 181_i, . . . , 181_M) obtained from the plurality of anonymization surveillance cameras 100 coupled to the network 500. In addition, the storage section 420 stores a subject recognition AI 184 obtained by performing federated learning in the controller 430. The subject recognition AI 184 is an AI model obtained by performing federated learning with use of the plurality of subject recognition AIs 181 (181_1, 181_2, . . . , 181_i, . . . , and 181_M). The controller 430 performs federated learning with use of the plurality of subject recognition AIs 181 (181_1, 181_2, . . . , 181_i, . . . , 181_M) to generate the subject recognition AI 184.

The communication section 410 transmits the subject recognition AI 184 generated by the controller 430 to each of the anonymization surveillance cameras 100 through the network 500. In a case where each of the anonymization surveillance cameras 100 obtains the subject recognition AI 184 through the network 500, each of the anonymization surveillance cameras 100 replaces the AI model used in the subject recognition section 140 and the subject recognition AI 181 with the subject recognition AI 184.

In the present modification example, the AI model used in the subject recognition section 140 and the subject recognition AI 181 are replaced with the subject recognition AI 184 at regular intervals. This makes it possible to perform subject identification with higher accuracy.

### 3. Application Examples

### 3-1. Entire Configuration of System

FIG. 7 is a block diagram illustrating a schematic configuration example of an information processing system 600 to which the anonymization surveillance camera 100 described above is applied. As illustrated in the drawing, the information processing system 600 includes at least a cloud server 1, a user terminal 2, a plurality of cameras 3, a fog server 4, and a management server 5. In this example, at least the cloud server 1, the user terminal 2, the fog server 4, and the management server 5 are able to communicate with each other through, for example, a network 6 such as the Internet.

The cloud server 1, the user terminal 2, the fog server 4, and the management server 5 are each configured as an information processing device including a microcomputer. The microcomputer includes a CPU (Central Processing Unit), a ROM (Read Only Memory), and a RAM (Random Access Memory).

Herein, the user terminal 2 is an information processing device that is assumed to be used by a user who is a recipient of a service using the information processing system 600. In addition, the management server 5 is an information processing device that is assumed to be used by a service provider.

Each of the cameras 3 includes, for example, an image sensor such as a CCD (Charge Coupled Device) image sensor or a CMOS (Complementary Metal Oxide Semi-conductor) image sensor, and captures an image of a subject and obtains image data (captured image data) as digital data. In addition, as described later, each of the cameras 3 has a function of performing processing (e.g., image recognition processing or image detection processing) using AI (Artificial Intelligence) on the captured image. In the following description, various kinds of processing on an image such as image recognition processing and image detection processing are simply referred to as “image processing”. For example, various kinds of processing on an image with use of AI (or an AI model) are referred to as “AI image processing”. Each of the cameras 3 corresponds to the anonymization surveillance camera 100 described above. Each of the cameras 3 is able to perform data communication with the fog server 4, and is able to transmit, to the fog server 4, various kinds of data such as processing result information indicating a result of processing (such as image processing) using AI, and to receive various kinds of data from the fog server 4.

Herein, the information processing system 600 illustrated in FIG. 7 is intended to be used, for example, for causing the fog server 4 or the cloud server 1 to generate analysis information about the subject on the basis of the processing result information obtained by image processing by each of the cameras 3, and allowing a user to browse the generated analysis information through the user terminal 2.

In this case, it is conceivable that each of the cameras 3 is used for any of various surveillance cameras. Examples of various surveillance cameras include a surveillance camera for indoor use in a store, an office, or a house, a surveillance camera (including a traffic surveillance camera and the like) for monitoring the outdoors such as a parking lot or a town, a surveillance camera for a production line in FA (Factory Automation) or IA (Industrial Automation), and a surveillance camera for monitoring inside or outside a vehicle.

For example, for use as a surveillance camera in a store, it is conceivable that a plurality of cameras 3 is disposed at predetermined positions in the store so as to allow a user to confirm segments (such as gender and age) of customers or behaviors (flow lines) of customers in the store. In this case, as the analysis information described above, it is conceivable to generate information about the segments of the customers, information about the flow lines of the customers in the store, information about congestion at a cash register (e.g., waiting time at the cash register), or the like. Alternatively, for use as a traffic surveillance camera, it is conceivable that the cameras 3 are disposed at respective positions near roads so as to allow the user to recognize information about the numbers (vehicle numbers), colors, models, and the like of passing vehicles. In this case, as the analysis information described above, it is conceivable to generate information about the numbers, colors, models, and the like of the vehicles.

In addition, in a case where a traffic surveillance camera is used in a parking lot, it is conceivable that a camera is disposed so as to allow for monitoring of each parking vehicle to monitor whether or not a suspicious person who exhibits a suspicious behavior is present around each vehicle, and in a case where a suspicious person is present, a notification is made of the presence of a suspicious person or the attribute (such as gender and age) of the suspicious person. Furthermore, it is conceivable that a camera monitors a vacant space in a town or a parking lot and a user is notified of the location of an available space for car parking.

The fog server 4 is assumed to be disposed for each monitoring target. For example, for use in the store described above, the fog server 4 is disposed together with each of the cameras 3 in the store as a monitoring target. Providing the fog server 4 for each monitoring target such as a store in such a manner eliminates a need for the cloud server 1 to directly receive transmission data from a plurality of cameras 3 in the monitoring target, which reduces the processing load of the cloud server 1.

It is to be noted that, in case where there are a plurality of stores as monitoring targets and all the stores belong to the same affiliated group, it is conceivable to provide one fog server 4 not for each store but for the plurality of stores. In other words, it is possible to provide one fog server 4 not only for each monitoring target but also for a plurality of monitoring targets.

It is to be noted that, in a case where it is possible to provide the cloud server 1 or each of the cameras 3 with a function of the fog server 4, for example, because of a reason that the cloud server 1 or each of the cameras 3 has processing capacity, the information processing system 600 may not include the fog server 4, and each of the cameras 3 may be directly coupled to the network 6 to cause the cloud server 1 to directly receive transmission data from the plurality of cameras 3.

It is possible to broadly classify various kinds of devices described above as cloud-side information processing devices or edge-side information processing devices. The cloud server 1 and the management server 5 correspond to the cloud-side information processing devices, and are a device group that provides a service that is assumed to be used by a plurality of users.

In addition, the cameras 3 and the fog server 4 correspond to the edge-side information processing devices, and it is possible to regard the cameras 3 and the fog server 4 as a device group disposed in an environment prepared by a user using a cloud service.

Note that both the cloud-side information processing devices and the edge-side information processing devices may be disposed in an environment prepared by the same user.

It is to be noted that the fog server 4 may be an on-premises server.

### 3-2. Registration of AI Model and AI Application

As described above, in the information processing system 300, AI image processing is performed in the camera 3 that is an edge-side information processing device, and in the cloud server 1 that is a cloud-side information processing device, an advanced application function is implemented with use of result information of the AI image processing on edge side (e.g., result information of image recognition processing using AI).

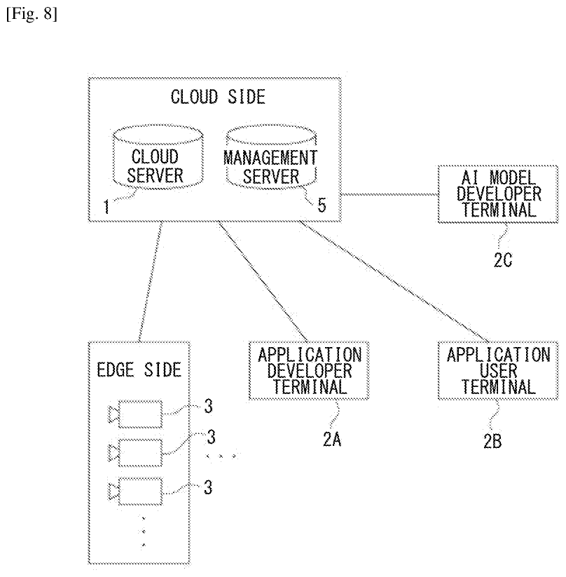

Herein, various techniques are considered for registering an application function in the cloud server 1 (or including the fog server 4) as a cloud-side information processing device. As one example, one of the techniques is described with reference to FIG. 8. It is to be noted that the fog server 4 is not illustrated in FIG. 8, but a configuration including the fog server 4 may be adopted. The fog server 4 in this case may have a part of an edge-side function.

The cloud server 1 and the management server 5 described above are information processing devices that configure a cloud-side environment. In addition, the camera 3 is an information processing device that configures an edge-side environment.

It is to be noted that it is possible to regard the camera 3 as a device including a controller that performs overall control of the camera 3, and to regard the camera 3 as a device including another device as an image sensor IS including an operation processor. The operation processor performs various kinds of processing including AI image processing on a captured image. In other words, it may be considered that inside the camera 3 that is an edge-side information processing device, the image sensor IS that is another edge-side information processing device is mounted.

In addition, examples of the user terminal 2 to be used by a user who uses various kinds of services provided by the cloud-side information processing device include an application developer terminal 2A, an application user terminal 2B, an AI model developer terminal 2C, and the like. The application developer terminal 2A is used by a user who develops an application to be used for AI image processing. The application user terminal 2B is used by a user who uses an application. The AI model developer terminal 2C is used by a user who develops an AI model to be used for AI image processing. It is to be noted that the application developer terminal 2A may be used by a user who develops an application not using AI image processing.

In the cloud-side information processing device, a learning data set for performing learning by AI is prepared. The user who develops an AI model communicates with the cloud-side information processing device with use of the AI model developer terminal 2C, and downloads the learning data set. In this case, the learning data set may be provided on a chargeable basis. For example, an AI model developer may purchase the learning data set in a state in which the AI model developer is enabled to purchase various functions and materials registered in a market place (electronic market) prepared as a cloud-side function by registering personal information in the market place.

After the AI model developer develops an AI model with use of the learning data set, the AI model developer registers the developed AI model in the market place with use of the AI model developer terminal 2C. Accordingly, in a case where the AI model is downloaded, an incentive charge may be paid to the AI model developer.

In addition, a user who develops an application downloads an AI model from the market place with use of the application developer terminal 2A, and develops an application using the AI model (hereinafter referred to as an “AI application”). In this case, as described above, an incentive charge may be paid to the AI model developer.

The application development user registers the developed AI application in the market place with use of the application developer terminal 2A. Accordingly, in a case where the AI application is downloaded, an incentive charge may be paid to a user who has developed the AI application.

A user who uses an AI application uses the application user terminal 2B to perform an operation for deploying an AI application and an AI model from the market place to the camera 3 as an edge-side information processing device managed by the user oneself. In this case, an incentive charge may be paid to the AI model developer. Accordingly, it is possible to perform AI image processing using the AI application and the AI model in the camera 3, and it is possible not only to capture an image, but also to perform detection of a customer or detection of a vehicle by the AI image processing.

Herein, deployment of the AI application and the AI model indicates that the AI application and the AI model are installed on a target (device) as an execution subject so as to allow the target as the execution subject to use the AI application and the AI model, that is, to execute at least a part of a program as the AI application.

In addition, in the camera 3, it may be possible to extract attribute information about customers from a captured image captured by the camera 3. The attribute information is transmitted from the camera 3 to the cloud-side information processing device through the network 6.

A cloud application is deployed to the cloud-side information processing device, and each user is able to use the cloud application through the network 6. In the cloud application, for example, an application for analyzing flow lines of customers with use of the attribute information about customers and the captured image is prepared. Such a cloud application is uploaded by an application development user or the like.

The application user uses the cloud application for flow line analysis with use of the application user terminal 2B, which makes it possible to analyze the flow lines of customers in a store of the application user and browse an analysis result. Browsing of the analysis result is performed, for example, by graphically presenting the flow lines of the customers on the map of the store.

In addition, browsing of the analysis result may be performed by displaying a result of flow line analysis in a heat map format and presenting customer density or the like. In addition, these pieces of information may be sorted and displayed for each customer attribute information.

In the market place on cloud side, AI models optimized for respective users may be registered. For example, a captured image captured by the camera 3 disposed in a store managed by a certain user is appropriately uploaded to and accumulated in the cloud-side information processing device.

In the cloud-side information processing device, relearning processing on the AI model is performed every time a predetermined number of uploaded captured images are accumulated, and processing for updating the AI model and reregistering the AI model in the market place is executed. It is to be noted that, for example, the user may select the relearning processing on the AI model as an option in the market place.

For example, the AI model relearned with use of a dark image from the camera 3 disposed in the store is deployed to that camera 3, which makes it possible to improve a recognition rate or the like of image processing on a captured image captured at a dark place. In addition, the AI model relearned with use of a bright image from the camera 3 disposed outside the store is deployed to that camera 3, which makes it possible to improve a recognition rate or the like of image processing on an image captured at a bright place. In other words, the application user redeploys the updated AI model to the camera 3, which makes it possible to obtain always-optimized processing result information. It is to be noted that relearning processing on the AI model is described later.

In addition, in a case where information (such as a capture image) uploaded from the camera 3 to the cloud-side information processing device includes personal information, data from which information related to privacy is eliminated, or reduced as described above in terms of privacy protection may be uploaded, or the AI model development user or the application development user may be allowed to use the data from which information related to privacy is eliminated, or reduced as described above.

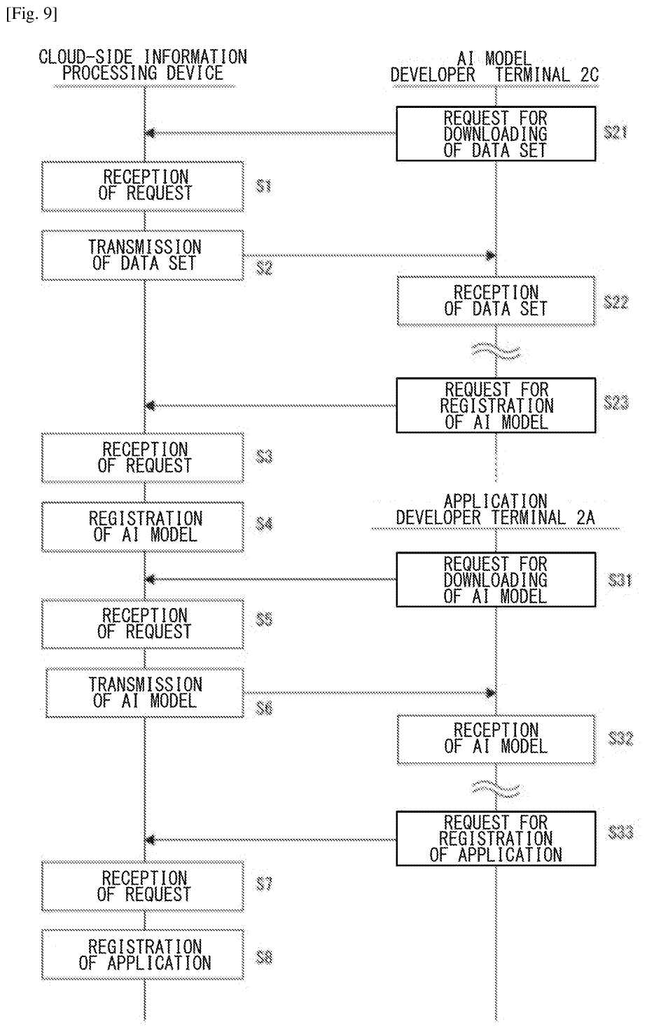

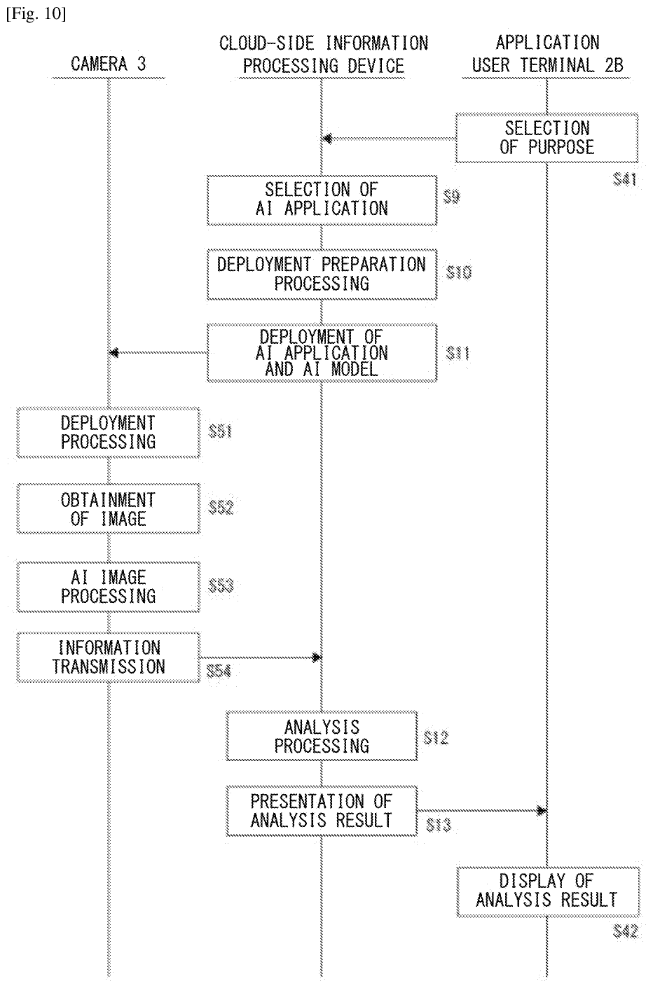

FIGS. 9 and 10 each illustrate a flow of processing described above in a flowchart. It is to be noted that the cloud-side information processing device corresponds to the cloud server 1, the management server 5, or the like in FIG. 7.

The AI model developer browses a list of data sets registered in the market place and selects a desired data set with use of the AI model developer terminal 2C including a display section. In response to this, the AI model developer terminal 2C transmits a request for downloading of the selected data set to the cloud-side information processing device in step S21. The display section includes an LCD (Liquid Crystal Display), an organic EL (Electro Luminescence) panel, or the like.

In response to the transmission of the request, the cloud-side information processing device receives the request in step S1, and performs processing for transmitting the requested data set to the AI model developer terminal 2C in step S2.

The AI model developer terminal 2C performs processing for receiving the data set in step S22. Thus, the AI model developer is able to develop an AI model with use of the data set.

After the AI model developer finishes development of the AI model, the AI model developer performs an operation for registering the developed AI model in the market place (e.g., specifies the name of the AI model, an address where the AI model is placed, or the like), which causes the AI model developer terminal 2C to transmit a request for registration of the AI model in the market place to the cloud-side information processing device in step S23.

In response to transmission of the request, the cloud-side information processing device receives the request for the registration of the AI model in step S3, and performs registration processing of the AI model in step S4, which makes it possible to display the AI model in the market place, for example. This allows a user other than the AI model developer to download the AI model from the market place.

For example, an application developer who intends to perform development of an AI application browses a list of AI models registered in the market place with use of the application developer terminal 2A. In response to an operation (e.g., an operation of selecting one of the AI models in the market place) by the application developer, the application developer terminal 2A transmits a request for downloading of the selected AI model to the cloud-side information processing device in step S31.

The cloud-side information processing device receives the request in step S5, and transmits the AI model to the application developer terminal 2A in step S6.

The application developer terminal 2A receives the AI model in step S32. This allows the application developer to develop the AI application with use of the AI model developed by another developer.

After the application developer finishes development of the AI application, the application developer performs an operation for registering the AI application in the market place (e.g., an operation of specifying the name of the AI application, an address where the AI application is placed, or the like), which causes the application developer terminal 2A to transmit a request for registration of the AI application in the market place to the cloud-side information processing device in step S33.

The cloud-side information processing device receives the request for the registration of the AI application in step S7, and registers the AI application in step S8, which makes it possible to display the AI application in the market place, for example. This allows a user other than the application developer to select the AI application on the market place and download the selected AI application.

For example, as illustrated in FIG. 10, in step S41, the application user terminal 2B performs purpose selection by a user who intends to use the AI application. In the purpose selection, a selected purpose is transmitted to the cloud-side information processing device.

In response to transmission of the selected purpose, the cloud-side information processing device selects an AI application corresponding to the purpose in step S9, and performs preparation processing (deployment preparation processing) for deploying the AI application or an AI model to each device in step S10.

In the deployment preparation processing, determination of the AI model, or the like is performed in accordance with information about a device to which the AI model and the AI application are to be deployed, e.g., information about the camera 3 or the fog server 4, performance requested by the user, and the like. In addition, in the deployment preparation processing, it is determined which device is cased to execute each of SW (Software) components included in an AI application for implementing a function desired by the user, on the basis of performance information of each device and request information of the user.

Each of the SW components may be a container to be described later, or may be a microservice. It is to be noted it is possible to implement the SW component even with use of a web assembly technology.

An AI application that counts the number of customers for each attribute such as gender or age includes an SW component that detects the face of a person from a captured image with use of an AI model, an SW component that extracts attribute information about the person from a face detection result, an SW component that aggregates results, an SW component that visualizes an aggregate result, and the like.

Some examples of the deployment preparation processing are described again later.

The cloud-side information processing device performs processing for deploying each SW component to each device in step S11. In this processing, the AI application and the AI model are transmitted to each device such as the camera 3.

In response to the transmission of the AI application and the AI model, the camera 3 performs deployment processing of the AI application and the AI model in step S51. This makes it possible to perform AI image processing on a captured image captured by the camera 3. It is to be noted that, although not illustrated in FIG. 10, the fog server 4 also performs deployment processing of the AI application and AI model similarly as necessary.

However, in a case where all pieces of processing are executed in the camera 3, the deployment processing is not performed in the fog server 4.

The camera 3 obtains an image by performing an imaging operation in step S52. The camera 3 then performs AI image processing on the obtained image in step S53 to obtain, for example, an image recognition result.

The camera 3 performs transmission processing of the captured image or result information of the AI image processing in step S54. In information transmission in step S54, both the captured image and the result information of the AI image processing may be transmitted, or only one of them may be transmitted.

The cloud-side information processing device that has received these pieces of information performs analysis processing in step S12. For example, analysis of flow lines of customers, vehicle analysis processing for traffic monitoring, or the like is performed by this analysis processing.

The cloud-side information processing device performs presentation processing of an analysis result in step S13. This processing is implemented, for example, by using the cloud application described above by the user.

The application user terminal 2B performs processing for displaying the analysis result on a monitor or the like in step S42 in response to the presentation processing of the analysis result.

The user who is a user of the AI application is able to obtain an analysis result corresponding to the purpose selected in step S41 by processing so far.

It is to be noted that, in the cloud-side information processing device, the AI model may be updated after step S13. Updating and deploying the AI model makes it possible to obtain an analysis result suitable for a usage environment of the user.

### 3-3. Summary of Function of System

In the present embodiment, a service that allows a user as a customer to select a kind of function about AI image processing of each camera 3 is assumed as a service using the information processing system 300. As selection of a kind of function, for example, an image recognition function, an image detection function, and the like may be selected, or a more specific kind may be selected to exhibit the image recognition function and the image detection function for a specific subject. For example, as a business model, a service provider sells the camera 3 and the fog server 4 that have an image recognition function by AI to a user, and disposes the camera 3 and the fog server 4 at locations to be monitored. Then, a service for providing analysis information as descried above to the user is deployed.

In this case, desired use of the system such as use for store monitoring or use for traffic monitoring differs for each customer; therefore, it is possible to selectively set an AI image processing function of the camera 3 so as to obtain analysis information corresponding to use desired by the user.

In this example, the management server 5 has such a function of selectively setting the AI image processing of the camera 3.

It is to be noted that the cloud server 1 or the fog server 4 may have the function of the management server 5.

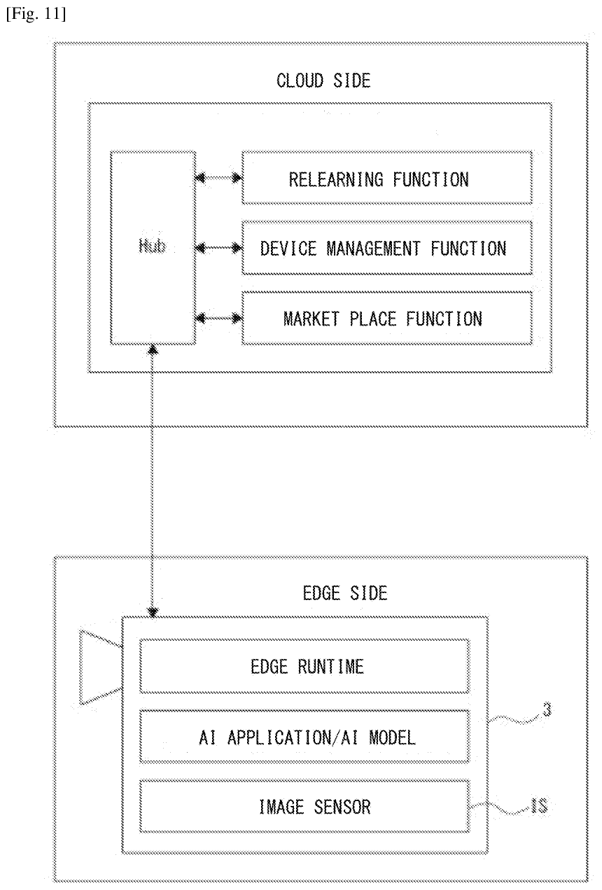

Herein, description is given of coupling of the cloud server 1 or the management server 5 that is the cloud-side information processing device to the camera 3 that is the edge-side information processing device with reference to FIG. 11.

The cloud-side information processing device has a relearning function, a device management function, and a market place function that are usable through a Hub.

The Hub performs secure and reliable communication with the edge-side information processing device. This makes it possible to provide various functions to the edge-side information processing device.

The relearning function is a function of providing a relearned and newly optimized AI model, and allows an appropriate AI model based on a new learning material to be provided.

The device management function is a function of managing the camera 3 or the like as the edge-side information processing device, and is allowed to provide a function such as management and monitoring of an AI model deployed to the camera 3, detection of trouble, and troubleshooting.

In addition, the device management function also serves as a function of managing information about the camera 3 and the fog server 4. The information about the camera 3 and the fog server 4 includes information about a chip used as an operation processor, a memory capacity and a storage capacity, information about usage rates of a CPU and a memory, information about software such as an OS (Operating System) installed on each device, and the like.

Furthermore, the device management function protects an secure access by an authorized user.

The market place function provides, for example, a function of registering an AI model developed by the AI model developer described above and an AI application developed by the application developer, and a function of deploying the developed AI model and the developed AI application to an authorized edge-side information processing device. In addition, the market place function also provides a function related to payment of an incentive charge for deployment of the developed AI model and the developed AI application.

The camera 3 as the edge-side information processing device includes an edge runtime, an AI application, an AI model, and the image sensor IS.

The edge runtime functions as, for example, embedded software for performing management of an application deployed to the camera 3 and communication with the cloud-side information processing device.

As described above, the AI model is a deployed AI model registered in the market place in the cloud-side information processing device, and the AI model makes it possible for camera 3 to obtain result information of AI image processing corresponding to a purpose with use of a captured image.

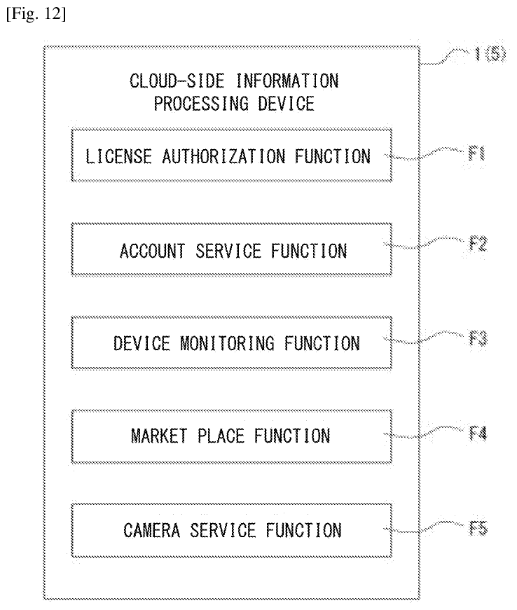

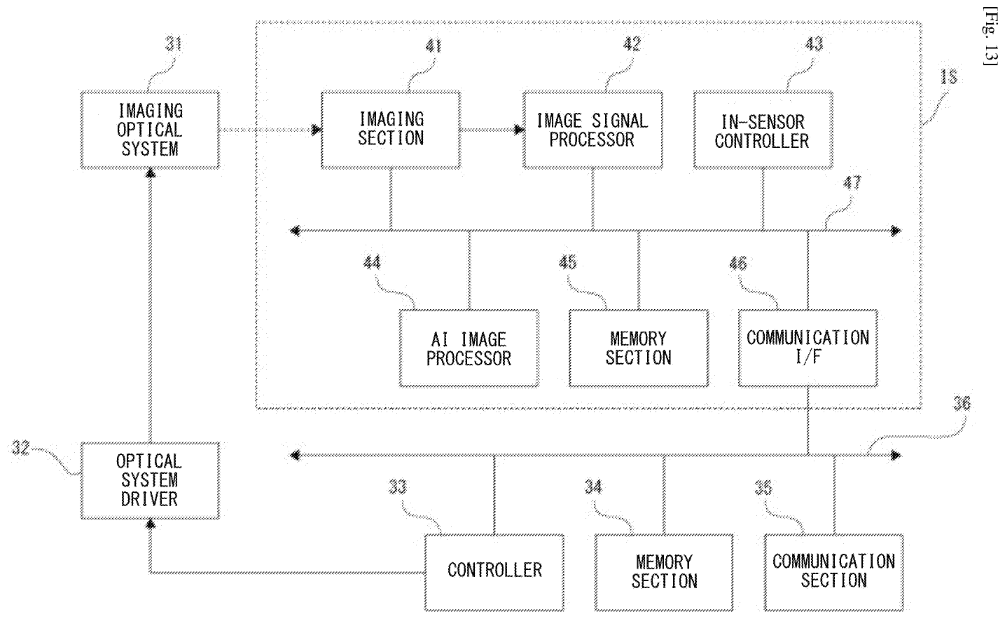

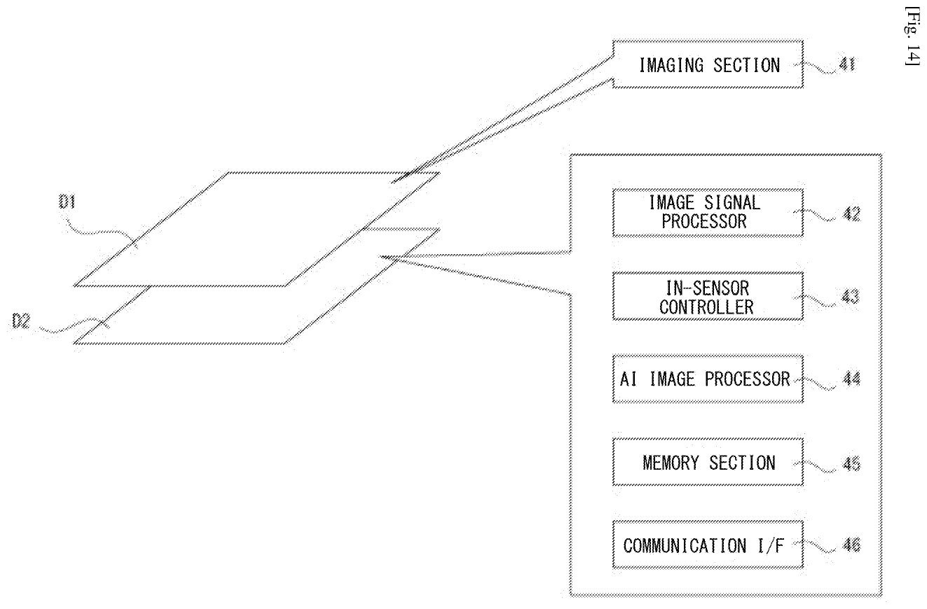

Description is given of summary of functions of the cloud-side information processing device with reference to FIG. 12. It is to be noted that the cloud-side information processing device is a generic name for devices such as the cloud server 1 and the management server 5. The cloud-side information processing device has a license authorization function F1, an account service function F2, a device monitoring function F3, a market place function F4, and a camera service function F5, as illustrated in the drawing.

The license authorization function F1 is a function of performing processing related to various authentications. Specifically, in the license authorization function F1, processing related to device authentication of each camera 3, and processing related to authentication of each of an AI model, software, and firmware to be used by the camera 3 are performed.

Herein, the software described above means software necessary to appropriately implement AI image processing in the camera 3. In order to appropriately perform AI image processing based on a captured image and transmit a result of the AI image processing in an appropriate format to the fog server 4 or the cloud server 1, it is requested to control data input to the AI model and appropriately process output data of the AI model. The software described above is software including peripheral processing necessary for appropriately implementing the AI image processing. Such software is software for implementing a desired function with use of the AI model, and corresponds to the AI application described above.

It is to be noted that, as the AI application, not only an AI application using only one AI model, but also AI application using two or more AI models is considered. For example, an AI application may be present that has a processing flow in which information about a recognition result (which include image data or the like, and is hereinafter referred to as “recognition result information”) obtained by an AI model that executes AI image processing on a capture image as input data is inputted to another AI model to execute second AI image processing.

In the license authorization function F1, as for authentication of the camera 3, in a case of coupling to the cameras 3 through the network 6, processing for issuing a device ID (Identification) to each of the cameras 3 is performed.

In addition, as for authentication of the AI model and software, processing is performed for issuing respective IDs (an AI model ID and a software ID) specific to an AI model and an AI application that have been applied for registration from the AI model developer terminal 2C and a software developer terminal 7. In addition, in the license authorization function F1, processing for issuing various keys, certificates and the like to a manufacturer of the camera 3 (specifically, a manufacturer of the image sensor IS to be described later), an AI model developer, and a software developer is performed, and processing for updating and suspension of certificate validity is also performed. The various keys, certificates and the like allow for secure communication between each of the camera 3, the AI model developer terminal 2C, and the software developer terminal 7, and the cloud server 1.

Furthermore, in the license authorization function F1, in a case where user registration (registration of account information with issuing of a user ID) is performed by the account service function F2 to be described below, processing for associating the camera 3 (the device ID described above) purchased by the user with the user ID is also performed.

The account service function F2 is a function of generating and managing user account information. In the account service function F2, input of user information is received, and account information based on the inputted user information is generated (account information including at least the user ID and password information is generated). In addition, in the account service function F2, registration processing (registration of account information) about the AI model developer and an AI application developer (hereinafter also referred to as a “software developer”) is also performed.

The device monitoring function F3 is a function of performing processing for monitoring the usage state of the camera 3. For example, monitoring of information about usage rates of a CPU and a memory to be used in AI image processing as various elements related to the usage state of the camera 3 is performed. The various elements include a location where the camera 3 is used, output frequency of output data of AI image processing, and free capacities of the CPU and the memory described above.

The market place function F4 is a function for selling AI models and AI applications. For example, the user is able to purchase an AI application and an AI model to be used by an AI application through a sales WEB site (a sales site) provided by the market place function F4. In addition, the software developer is able to purchase an AI model for creation of an AI application through the sales site described above.

The camera service function F5 is a function for providing a service related to use of the camera 3 to the user. One example of the camera service function F5 is a function related to generation of the analysis information described above. In other words, the camera service function F5 is a function of performing processing for generating analysis information about the subject on the basis of processing result information of image processing in the camera 3 and causing the user to browse the generated analysis information through the user terminal 2.

In addition, the camera service function F5 includes an imaging setting search function. Specifically, this imaging setting search function is a function of obtaining recognition result information of AI image processing from the camera 3 and searching imaging setting information about the camera 3 with use of AI on the basis of obtained recognition result information. Herein, the imaging setting information broadly means setting information related to an imaging operation for obtaining a captured image. Specifically, the imaging setting information includes a wide variety of setting such as optical setting such as focus and a diaphragm, setting related to a captured image signal reading operation such as a frame rate, an exposure time, and a gain, and setting related to image signal processing on the read captured image signal such as gamma correction processing, noise reduction processing, and super-resolution processing.

In addition, the camera service function F5 also includes an AI model search function. This AI model search function is a function of obtaining recognition result information of the AI image processing from the camera 3 and searching an optimum AI model to be used in the AI image processing in the camera 3 with use of AI on the basis of the obtained recognition result information. AI model search herein means, for example, processing for optimizing setting information (including, for example, information about a kernel size) related to various processing parameters such as a weight coefficient, and a neural network structure in a case where the AI image processing is implemented by a CNN (Convolutional Neural Network) including a convolution operation, or the like.

In addition, the camera service function F5 includes a processing sharing determination function. In the processing sharing determination function, upon deploying an AI application to the edge-side information processing device, as the deployment preparation processing described above, processing for determining a deployment destination device for each SW component is performed. It is to be noted that some of SW components may be determined as SW components to be executed in a cloud-side device, and in this case, the SW components may not be subjected to deployment processing because the SW components have been already deployed to the cloud-side device.

For example, as with the example described above, in a case of an AI application including an SW component that detects the face of a person, an SW component that extracts attribute information about the person, an SW component that aggregates extraction results, and an SW component that visualizes an aggregate result, the camera service function F5 determines the image sensor IS of the camera 3 as a deployment destination device of the SW component that detects the face of the person, determines the camera 3 as a deployment destination device of the SW component that extracts the attribute information about the person, determines the fog server 4 as a deployment destination device of the SW component that aggregates extraction results, and determines the SW component that visualizes the totalization result as being executed in the cloud server 1 without being newly deployed to a device.

Thus, processing sharing of each device is determined by determining a deployment destination of each SW component. It is to be noted that such determination is made in consideration of specifications and performance of each device and a request by the user.

Having the imaging setting search function and the AI model search function described above makes it possible to cause imaging setting that achieves a favorable result of AI image processing to be performed, and to cause AI image processing to be performed with use of an appropriate AI model corresponding to an actual usage environment. Furthermore, having the processing sharing determination function in addition to these functions makes it possible to cause AI image processing and processing for analysis of the AI image processing to be executed by an appropriate device.

It is to be noted that the camera service function F5 has an application setting function prior to deployment of each SW component. The application setting function is a function of setting an appropriate AI application depending on a user's purpose.

For example, an appropriate AI application is selected in response to selection of use such as store monitoring or traffic monitoring by the user. Thus, SW components included in the AI application are automatically determined. It is to be noted that, as described later, there may be a plurality of combinations of SW components for achieving the user's purpose with use of the AI application, and in this case, one combination is selected in accordance with information about the edge-side information processing device and a user's request.

For example, in a case where the purpose of the user is store monitoring, a combination of SW components with emphasis on privacy may be different from a combination of SW components with emphasis on speed.

In the application setting function, the user terminal 2 (corresponding to the application user terminal 2B in FIG. 8) performs, for example, processing for receiving an operation of selecting a purpose (application) by the user, or processing for selecting an appropriate AI application corresponding to the selected application.

Herein, a configuration in which the license authorization function F1, the account service function F2, the device monitoring function F3, the market place function F4, and the camera service function F5 are implemented by the cloud server 1 alone has been described above as an example; however, a configuration in which these functions are shared and implemented by a plurality of information processing devices is adoptable. For example, a configuration in which each of the information processing devices has one of the functions described above is conceivable. Alternatively, it is possible to share a single function of the functions described above by a plurality of information processing devices (e.g., the cloud server 1 and the management server 5).

In FIG. 7, the AI model developer terminal 2C is an information processing device used by the AI model developer. In addition, the software developer terminal 7 is an information processing device used by the AI application developer.

### 3-4. Configuration of Imaging Device

FIG. 13 is a block diagram illustrating an internal configuration example of the camera 3. As illustrated in the drawing, the camera 3 includes an imaging optical system 31, an optical system driver 32, the image sensor IS, a controller 33, a memory section 34, and a communication section 35. The image sensor IS, the controller 33, the memory section 34, and the communication section 35 are coupled to each other through a bus 36, and are able to perform data communication with each other.

The imaging optical system 31 includes lenses such as a cover lens, a zoom lens, or a focus lens, and a diaphragm (iris) mechanism. The imaging optical system 31 guides light (incident light) from a subject, and condenses the light onto a light-receiving surface of the image sensor IS.

The optical system driver 32 comprehensively indicates a driver of the zoom lens, the focus lens, and the diaphragm mechanism included in the imaging optical system 31. Specifically, the optical system driver 32 includes an actuator for driving each of the zoom lens, the focus lens, and the diaphragm mechanism, and a drive circuit of the actuator.

The controller 33 includes, for example, a microcomputer including a CPU, a ROM, and a RAM. The CPU performs overall control of the camera 3 by executing various kinds of processing according to a program stored in the ROM or a program loaded on the RAM.

In addition, the controller 33 instructs the optical system driver 32 to drive the zoom lens, the focus lens, the diaphragm mechanism, or the like. The optical system driver 32 causes movement of the focus lens and the zoom lens and opening/closing of a blade of the diaphragm mechanism to be executed in response to such a driving instruction.

In addition, the controller 33 controls writing and reading of various kinds of data to and from the memory section 34. The memory section 34 includes, for example, a non-volatile storage device such as a HDD (Hard Disk Drive) or a flash memory device, and is used as a storage destination (recording destination) of image data outputted from the image sensor IS.

Furthermore, the controller 33 performs various kinds of data communication with an external device through the communication section 35. The communication section 35 in this example is able to perform data communication with at least the fog server 4 (or the cloud server 1) illustrated in FIG. 1.

The image sensor IS is configured as, for example, a CCD or CMOS image sensor.

The image sensor IS includes an imaging section 41, an image signal processor 42, a in-sensor controller 43, an AI image processor 44, a memory section 45, and a communication I/F 46, which are able to perform data communication with each other through a bus 47.

The imaging section 41 includes a pixel array section and a readout circuit. The pixel array section includes pixels that each include a photoelectric conversion element such as a photodiode and are two-dimensionally arranged. The readout circuit reads an electrical signal obtained by photoelectric conversion from each of the pixels included in the pixel array section. The imaging section 41 is able to output the electrical signal as a captured image signal.

The readout circuit executes, for example, CDS (Correlated Double Sampling) processing, AGC(Automatic Gain Control) processing, and the like on the electrical signal obtained by photoelectric conversion, and further performs A/D (Analog/Digital) conversion processing.

The image signal processor 42 performs preprocessing, synchronization processing, YC generation processing, resolution conversion processing, codec processing, and the like on the captured image signal as digital data having been subjected to the A/D conversion processing. In the preprocessing, clamp processing in which black levels of R, G, and B of the captured image signal are clamped to a predetermined level, correction processing between color channels of R, G, and B, and the like are performed. In the synchronization processing, color separation processing is performed to cause image data of each pixel to have all color components of R, G, and B. For example, in a case of an imaging element using color filters arranged in a Bayer array, demosaic processing is performed as color separation processing. In the YC generation processing, a luminance (Y) signal and a color (C) signal are generated (separated) from image data of R, G, and B. In the resolution conversion processing, resolution conversion processing is executed on image data having been subjected to various kinds of signal processing.

In the codec processing, for example, encoding processing for recording or for communication, and file generation are performed on the image data having been subjected to the various kinds of processing described above. In the codec processing, it is possible to generate a file in a format such as MPEG-2 (MPEG: Moving Picture Experts Group) or H.264 as a moving image file format. In addition, it is conceivable to generate a file as a still image file in a format such as JPEG (Joint Photographic Experts Group), TIFF (Tagged Image File Format), or GIF(Graphics Interchange Format).

The in-sensor controller 43 provides an instruction to the imaging section 41, and controls execution of an imaging operation. Likewise, the in-sensor controller 43 controls execution of processing in the image signal processor 42.

The AI image processor 44 performs image recognition processing as AI image processing on a captured image.

It is possible to implement an image recognition function using AI with use of, for example, a programmable operation processor such as a CPU, a FPGA (Field Programmable Gate Array), or a DSP (Digital Signal Processor).

The image recognition function that is implementable by the AI image processor 44 is switchable by changing an algorithm of AI image processing. In other words, switching the AI model to be used in the AI image processing makes it possible to switch the kind of function of the AI image processing. Various kinds of functions of the AI image processing are considered, and examples thereof include the following kinds.
Class identification
Semantic segmentation
Person detection
Vehicle detection
Target tracking
OCR (Optical Character Recognition)

Among the kinds of functions described above, the class identification is a function of identifying the class of a target. The “class” herein is information indicating the category of an object, and classifies the target into, for example, “human”, “automobile”, “airplane”, “vessel”, “truck”, “bird”, “cat”, “dog”, “deer”, “frog”, “horse”, or the like. The target tracking is a function of tracking a subject as the target. In other words, the target tracking is a function of obtaining history information about the position of the subject.

The memory section 45 is used as a storage destination of various kinds of data such as captured image data obtained by the image signal processor 42. In addition, in this example, it is possible to use the memory section 45 for temporary storage of data to be used by the AI image processor 44 in course of AI image processing.

In addition, information about an AI application and an AI model to be used in the AI mage processor 44 is stored in the memory section 45.

It is to be noted that information about the AI application and the AI model may be deployed to the memory section 45 as a container or the like with use of a container technology to be described later, or may be deployed with use of a microservice technology. Deploying the AI model to be used in the AI image processing to the memory section 45 makes it possible to change the kind of function of the AI image processing or change to an AI model having performance improved by relearning.

It is to be noted that, as described above, in the present embodiment, description based on an example about the AI model and the AI application to be used for image recognition has been given, but this is not limitative. A program or the like to be executed with use of an AI technology may be used for image recognition.

In addition, in a case where the capacity of the memory section 45 is small, after information about the AI application and the AI model is deployed as a container or the like to a memory such as the memory section 34 disposed outside the image sensor IS with use of the container technology, only the AI model may be stored in the memory section 45 in the image sensor IS through the communication I/F 46 to be described below.

The communication I/F 46 is an interface that communicates with the controller 33, the memory section 34, and the like that are disposed outside the image sensor IS. The communication I/F 46 performs communication for obtaining a program to be executed by the image signal processor 42, the AI application and the AI model to be used by the AI image processor 44, and the like from outside, and stores them in the memory section 45 included in the image sensor IS. Thus, the AI model is temporarily stored in a portion of the memory section 45 included in the image sensor IS, which makes it possible to use the AI model by the AI image processor 44.

The AI image processor 44 performs predetermined image recognition processing with use of the thus-obtained AI application and the thus-obtained AI model to perform recognition of the subject based on a purpose.

Recognition result information of the AI image processing is outputted to outside of the image sensor IS through the communication I/F 46.

In other words, not only image data outputted from the image signal processor 42 but also the recognition result information of the AI image processing is outputted from the communication I/F 46 of the image sensor IS. It is to be noted that it is possible to output only one of the image data and the recognition result information from the communication I/F 46 of the image sensor IS.

For example, in a case where the function of relearning the AI model described above is used, captured image data to be used for the relearning function is uploaded from the image sensor IS to the cloud-side information processing device through the communication I/F 46 and the communication section 35.

In addition, in a case where inference with use of the AI model is performed, the recognition result information of the AI image processing is outputted from the image sensor IS to another information processing device disposed outside the camera 3 through the communication I/F 46 and the communication section 35.

Various configurations of the image sensor IS are considered. Herein, description is given of an example in which the image sensor IS includes a structure in which two layers are stacked.

The image sensor IS is configured as a one-chip semiconductor device in which two dies are stacked.

The image sensor IS includes a die D1 and a die D2 that are stacked. The die D1 functions as the imaging section 41 illustrated in FIG. 13, and the die D2 includes the image signal processor 42, the in-sensor controller 43, the AI image processor 44, the memory section 45, and the communication I/F 46.

The die D1 and the die D2 are electrically coupled to each other by, for example, Cu—Cu bonding.

Various methods of deploying the AI model, the AI application, or the like to the camera 3 are considered. An example using the container technology is described as one example.

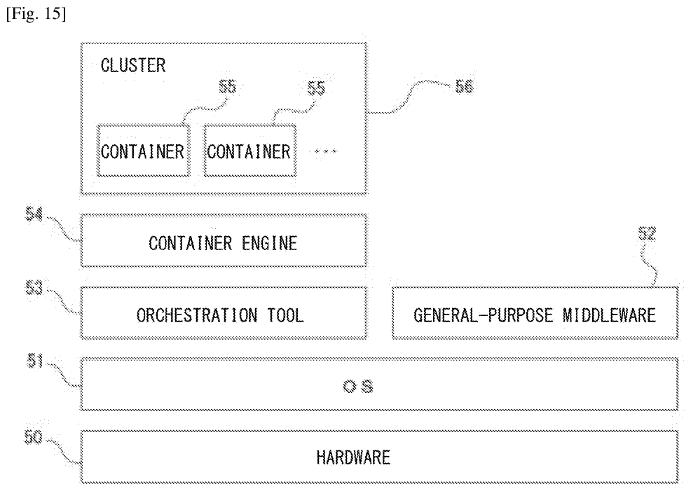

In the camera 3, an operation system 51 is installed on a CPU or a GPU (Graphics Processing Unit) as the controller 33 illustrated in FIG. 13 and various kinds of hardware 50 such as a ROM and a RAM (see FIG. 15).

The operation system 51 includes basic software that performs overall control of the camera 3 to implement various functions in the camera 3.

General-purpose middleware 52 is installed on the operation system 51.

The general-purpose middleware 52 includes, for example, software for implementing a basic operation such as a communication function using the communication section 35 as hardware 50 and a display function using a display section (such as a monitor) as the hardware 50.

Not only the general-purpose middleware 52 but also an orchestration tool 53 and a container engine 54 are installed on the operation system 51.

The orchestration tool 53 and the container engine 54 perform deployment and execution of the container 55 by constructing a cluster 56 as an operation environment of the container 55. It is to be noted that the edge runtime illustrated in FIG. 11 corresponds to the orchestration tool 53 and the container engine 54 illustrated in FIG. 15.

The orchestration tool 53 has a function for causing the container engine 54 to appropriately perform resource allocation of the hardware 50 and the operation system 51 described above. Respective containers 55 are collected in predetermined units (pods to be described later) by the orchestration tool 53, and each of the pods is deployed to a worker node (to be described later) that is a logically different area.

The container engine 54 is one piece of middleware installed on the operation system 51, and is an engine that operates the container 55. Specifically, the container engine 54 has a function of allocating resources (such as a memory and computing power) of the hardware 50 and the operation system 51 to the container 55 on the basis of a setting file or the like included in the middleware in the container 55.

In addition, in the present embodiment, the resources to be allocated include not only resources of the controller 33 and the like included in the camera 3 but also resources of the in-sensor controller 43, the memory section 45, the communication I/F 46, and the like included in the image sensor IS.

The container 55 includes an application for implementing a predetermined function and middleware such as a library. The container 55 operates to implement the predetermined function with use of the resources of the hardware 50 and the operation system 51 allocated by the container engine 54.

In the present embodiment, the AI application and the AI model illustrated in FIG. 11 corresponds to one of the containers 55. In other words, one of various containers 55 deployed to the camera 3 implements a predetermined AI image processing function using the AI application and the AI model.

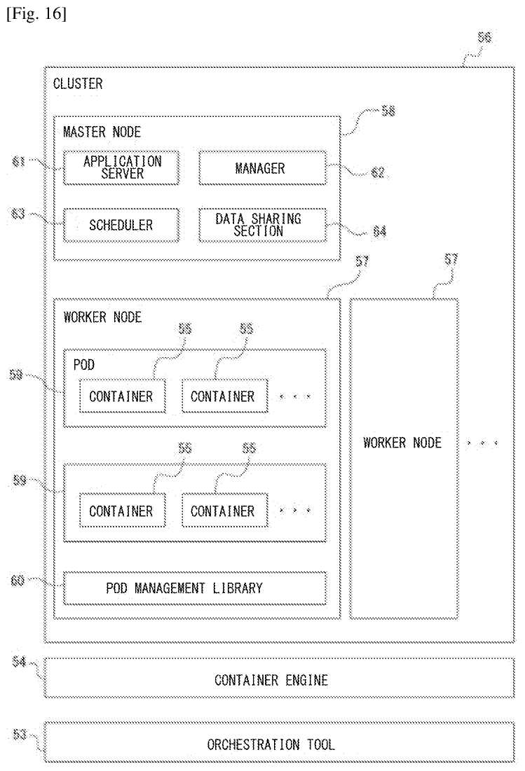

Description is given of a specific configuration example of the cluster 56 constructed by the container engine 54 and the orchestration tool 53 with reference to FIG. 16. It is to be noted that the cluster 56 may be constructed over a plurality of devices so as to implement a function with use of resources of not only the hardware 50 included in one camera 3 but also another hardware included in another device.

The orchestration tool 53 manages the execution environment of the containers 55 in units of the worker nodes 57. In addition, the orchestration tool 53 constructs a master node 58 that manages all the worker nodes 57.

In the worker node 57, a plurality of pods 59 is deployed. The pods 59 each include one or a plurality of containers 55, and implement a predetermined function. The pod 59 is a management unit for managing the containers 55 by the orchestration tool 53.

The operation of the pod 59 in the worker node 57 is controlled by a pod management library 60.

The pod management library 60 includes a container runtime for causing the pod 59 to use the logically allocated resource of the hardware 50, an agent that accepts control from the master node 58, a network proxy that performs communication between the pods 59 and communication with the master node 58, and the like. In other words, each of the pods 59 is able to implement a predetermined function using each resource by the pod management library 60.

The master node 58 includes an application server 61, a manager 62 a scheduler 63, and a data sharing section 64. The application server 61 performs deployment of the pod 59. The manager 62 manages the deployment conditions of the container 55 by the application server 61. The scheduler 63 determines the worker node 57 where the container 55 is disposed. The data sharing section 64 performs data sharing.

Using the configuration illustrated in FIGS. 15 and 16 makes it possible to deploy the AI application and the AI model described above to the image sensor IS of the camera 3 with use of the container technology.

It is to be noted that as described above, the AI model may be stored in the memory section 45 in the image sensor IS through the communication I/F 46 illustrated in FIG. 13 to execute AI image processing in the image sensor IS, or the configuration illustrated in FIGS. 15 and 16 may be deployed to the memory section 45 and the in-sensor controller 43 in the image sensor IS to execute the AI application and the AI model described above in the image sensor IS with use of the container technology.

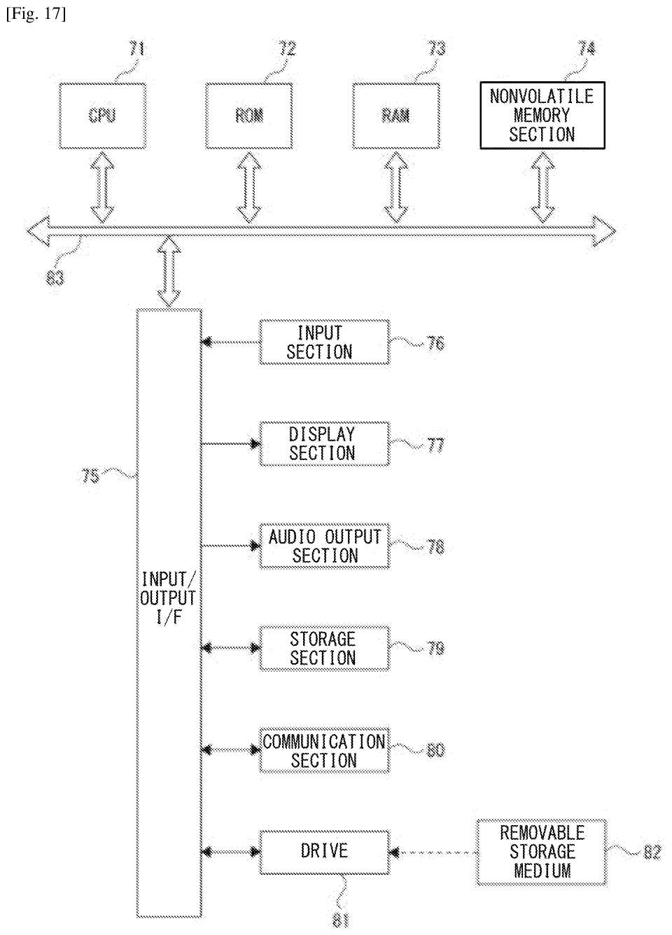

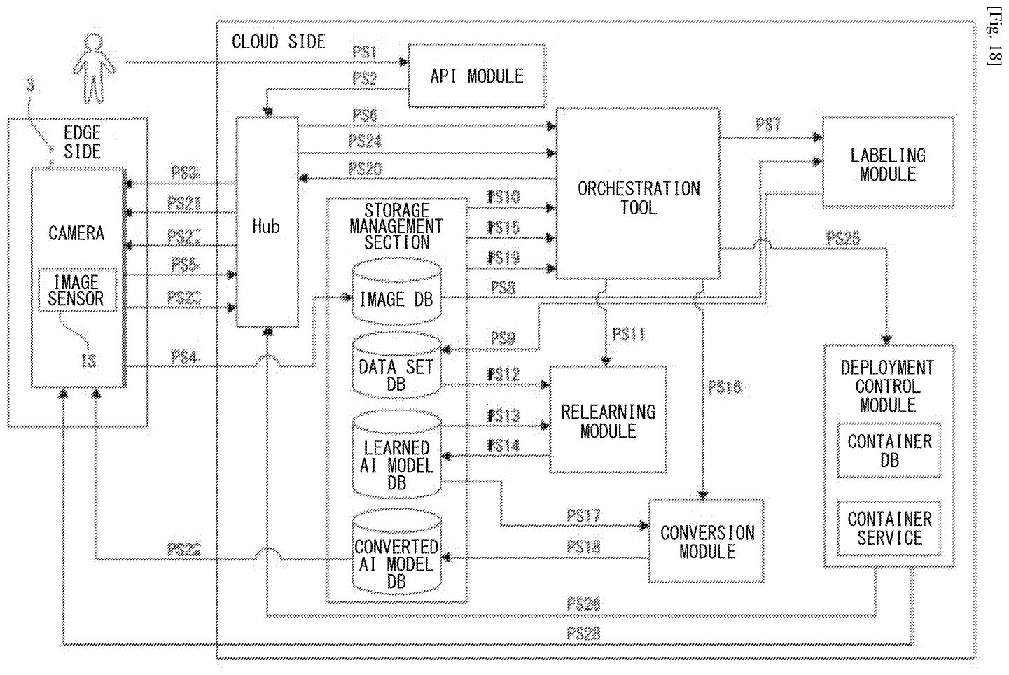

In addition, as described later, even in a case where the AI application and/or the AI model is deployed to the fog server 4 or the cloud-side information processing device, it is possible to use the container technology. In this case, information about the AI application and the AI model is deployed as a container or the like to a memory such as a nonvolatile memory section 74, a storage section 79, or a RAM 73 in FIG. 17 to be described later, and executed.

### 3-5. Hardware Configuration of Information Processing Device

Description is given of a hardware configuration of the information processing device such as the cloud server 1, the user terminal 2, the fog server 4, and the management server 5 included in the information processing system 600 with reference to FIG. 17.

The information processing device includes a CPU 71. The CPU 71 functions an operation processor that performs various kinds of processing described above, and executes various kinds of processing according to a program stored in the nonvolatile memory section 74 such as a ROM 72 or an EEP-ROM (Electrically Erasable Programmable Read-Only Memory), or a program loaded from the storage section 79 to the RAM 73. Data or the like necessary to execute various kinds of processing by the CPU 71 is also stored in the RAM 73 as appropriate.

It is to be noted that the CPU 71 included in the information processing device serving as the cloud server 1 functions as a license authorization section, an account service providing section, a device monitoring section, a market place function providing section, and a camera service providing section to implement respective functions described above.

The CPU 71, the ROM 72, the RAM 73, and the nonvolatile memory section 74 are coupled to each other through a bus 83. An input/output interface (I/F) 75 is also coupled to the bus 83.

An input section 76 including an operator and an operation device is coupled to the input/output interface 75. Various operators and operation devices such as a keyboard, a mouse, a key, a dial, a touch panel, a touch pad, and a remote controller are assumed as the input section 76. An operation by the user is detected by the input section 76, and a signal corresponding to the inputted operation is interpreted by the CPU 71.

In addition, a display section 77 including an LCD, an organic EL panel, or the like and an audio output section 78 such as a speaker are coupled integrally or separately to the input/output interface 75. The display section 77 is a display section that performs various kinds of display, and includes, for example, a display device provided on a housing of a computer device, a separate display device coupled to the computer device, or the like.

The display section 77 executes display of an image for various kinds of image processing or a moving image as a processing target on a display screen on the basis of an instruction from the CPU 71. In addition, the display section 77 performs display of various kinds of operation menus, an icon, a message, and the like, that is, display as a GUI (Graphical User Interface).

In some cases, the storage section 79 including a hard disk, a solid memory, or the like, or a communication section 80 including a modem or the like is coupled to the input/output interface 75.

The communication section 80 performs communication processing through a transmission path such as the Internet, wired/wireless communication with various devices, and communication by bus communication or the like.

A drive 81 is also coupled to the input/output interface 75 as necessary, and a removable storage medium 82 such as a magnetic disk, an optical disk, a magneto-optical disk, or a semiconductor memory is loaded on the drive 81 as appropriate.

It is possible to read a data file such as a program to be used for each processing from the removable storage medium 82 by the drive 81. The read data file is stored in the storage section 79, or an image or sound included in the data file are outputted to the display section 77 or the audio output section 78. In addition, a computer program or the like read from the removable storage medium 82 is installed on the storage section 79 as necessary.

In this computer device, for example, it is possible to install software for processing in the present embodiment through network communication by the communication section 80 or the removable storage medium 82. Alternatively, the software may be stored in advance in the ROM 72, the storage section 79, or the like. In addition, a captured image captured by the camera 3 or a processing result by AI image processing may be received, and stored in the removable storage medium 82 through the storage section 79 and the drive 81.

The CPU 71 performs a processing operation on the basis of various kinds of program, which causes information processing and communication processing necessary as the cloud server 1 that is the information processing device including the above-described operation processor to be executed.

It is to be noted that the cloud server 1 is not necessarily configured by a single computer device as illustrated in FIG. 12, and may be configured by systematizing a plurality of computer devices. The plurality of computer devices may be systematized by a LAN (Local Area Network) or the like, or may be disposed at remote sites by a VPN (Virtual Private Network) using the Internet or the like. The plurality of computer devices may include a computer device as a server group (cloud) usable by a cloud computing service.

### <4. Others

Specific description is given, with reference to FIG. 18, of a processing flow when relearning of the AI model and the updating of the AI model deployed to each camera 3 (hereinafter referred to as “edge-side AI model”) and the AI application are performed in response to an operation by a service provider or a user as a trigger after the SW components of AI application and the AI model are deployed as described above. It is to be noted that FIG. 18 illustrates one camera 3 of a plurality of cameras 3. In addition, the edge-side AI model as an updating target in the following description is an AL model deployed to the image sensor IS included in the camera 3; however, the edge-side AI model may be an AL model deployed to outside of the image sensor IS in the camera 3.

First, in processing step PS1, the service provider or the user provides an instruction for relearning of the AI model. This instruction is provided with use of an API function of an API (Application Programming Interface) module included in the cloud-side information processing device. In addition, in this instruction, an image amount (e.g., the number of sheets) to be used for learning is specified. Hereinafter, the image amount to be used for learning is also referred to as a “predetermined number of sheets”.

The API module receives the instruction, and transmits a request for relearning and information about the image amount to the Hub (similar to that illustrated in FIG. 11) in processing step PS2.

The Hub transmits a notification of updating and the information about the image amount to the camera 3 as the edge-side information processing device in processing step PS3.

The camera 3 transmits captured image data obtained by photographing to an image DB (Database) of a storage group in processing step PS4. This photographing processing and transmission processing are performed until reaching a predetermined number of sheets necessary for relearning.

It is to be noted that in a case where the camera 3 obtains an inference result by performing inference processing on the captured image data, the camera 3 may store the inference result as metadata of the captured image data in the image DB in processing step PS4.

Storing the inference result in the camera 3 as metadata in the image DB makes it possible to carefully select data necessary for relearning of the AI model to be executed on cloud side. Specifically, it is possible to perform relearning with use of only image data in which the inference result in the camera 3 is different from and a result of inference executed with use of sufficient computer resources in the cloud-side information processing device. Thus, it is possible to reduce time necessary for relearning.

After photographing and transmitting the predetermined number of sheets, the camera 3 provides, to the Hub, a notification that transmission of the predetermined number of sheets of captured image data is completed in processing step PS5.

In response to the notification, the Hub provides, to the orchestration tool, a notification that preparation of data for relearning is completed in processing step PS6.

The orchestration tool transmits an instruction for execution of labeling processing to a labeling module in processing step PS7.

The labeling module obtains image data to be subjected to the labeling processing from the image DB (processing step PS8), and performs the labeling processing.

The labeling processing herein may be processing for performing the class identification described above, processing for estimating the gender or age of a subject in an image and giving a label to the subject, processing for estimating the pose of the subject and giving a label to the subject, or processing for estimating the behavior of the subject and giving a label to the subject.

The labeling processing may be performed manually or automatically. In addition, the labeling processing may be completed by the cloud-side information processing device, or may be implemented with use of a service provided by another server device.

The labeling module that has completed the labeling processing stores information about a labeling result in a data set DB in processing step PS9. Herein, information stored in the data set DB may be a combination of label information and image data, or image ID (Identification) information for specifying image data instead of the image data itself.

A storage management section that has detected that the information about the labeling result has been stored gives a notification to the orchestration tool in processing step PS10.

The orchestration tool that has received the notification confirms that the labeling processing on the predetermined number of sheets of image data has been completed, and transmits an instruction for relearning to the relearning module in processing step PS11.

The relearning module that has received the instruction for relearning obtains a data set to be used for learning from the data set DB in processing step PS12, and obtains an AI model to be updated from a learned AI model DB in processing step PS13.

The relearning module performs relearning of the AI model with use of the obtained data set and the obtained AI model. The thus-obtained updated AI model is stored in the learned AI model DB again in processing step PS14.

The storage management section that has detected that the updated AI model has been stored gives a notification to the orchestration tool in processing step PS15.

The orchestration tool that has received the notification transmits an instruction for conversion of the AI model to a conversion module in processing step S16.

The conversion module that has received the instruction for conversion obtains the updated AI model from the learned AI model DB in processing step PS17, and performs conversion processing on the AI model. In the conversion processing, processing for performing conversion in accordance with information about specifications of the camera 3 that is a deployment destination device is performed. In this processing, downsizing is performed while minimizing reduction in performance of the AI model, and file format conversion or the like is performed to make the AI model operable on the camera 3.

The AI model converted by the conversion module is referred to as the edge-side AI model described above. This converted AI model is stored in a converted AI model DB in processing step PS18.

The storage management section that has detected that the converted AI model has been stored gives a notification to the orchestration tool in processing step PS19.

The orchestration tool that has received the notification transmits a notification for executing updating of the AI model to the Hub in processing step PS20. This notification includes information for specifying a location where the AI model to be used for updating is stored.

The hub that has received the notification transmits an instruction for updating of the AI model to the camera 3. The instruction for updating also includes information for specifying the location where the AI model to be used for updating is stored.

The camera 3 performs processing for obtaining a target converted AI model from the converted AI model DB and deploying the converted AI model in processing step PS22. Thus, the AI model to be used in the image sensor IS of the camera 3 is updated.

The camera 3 that has completed updating of the AI model by deploying the AI model transmits a notification that updating has been completed to the Hub in processing step SP23. The Hub that has received the notification provides, to the orchestration tool, a notification that the AI model updating processing in the camera 3 has been completed in processing step PS24.

It is to be noted that an example in which the AI model is deployed and used in the image sensor IS (e.g., the memory section 45 illustrated in FIG. 13) of the camera 3 has been described here; however, even in a case where the AI model is deployed and used outside the image sensor IS (e.g., the memory section 34 in FIG. 13) in the camera 3, it is possible to update the AI model in a similar manner.

In this case, a device (location) where the AI model has been deployed is stored in a cloud-side storage management section or the like upon deploying the AI model, and the Hub reads, from the storage management section, the device (location) where the AI model has been deployed, and transmits an instruction for updating of the AI model to the device to which the AI model has been deployed. The device that has received the instruction for updating performs processing for obtaining a target converted AI model from the converted AI model DB and deploying the converted AI model in processing step PS22. Thus, the AI model of the device that has received the instruction for updating is updated.

It is to be noted that in a case where only updating of the AI model is performed, updating is completed by processing so far. In a case where the AI application using the AI model is updated in addition to the AI model, processing to be described below is further executed.

Specifically, in processing step PS25, the orchestration tool transmits, to a deployment control module, an instruction for downloading the AI application such as updated firmware.

The deployment control module transmits, to the Hub, an instruction for deployment of the AI application in processing step PS26. This instruction includes information for specifying a location where the updated AI application is stored.

The Hub transmits the instruction for deployment to the camera 3 in processing step PS27.

The camera 3 downloads the updated AI application from a container DB of the deployment control module and deploys the updated AI application in processing step PS28.

It is to be noted that an example has been described above in which updating of the AI model that operates on the image sensor IS of the camera 3 and updating of the AI application that operates outside the image sensor IS in the camera 3 are sequentially performed. In addition, for simplification of description, the AI application has been described; however, the AI application is defined by a plurality of SW components such as SW components B1, B2, B3, . . . , Bn as described above. In a case where the AI application has been deployed, a location where each SW component has been deployed is stored in the cloud-side storage management section or the like, and in processing in processing step PS27, the Hub reads a device (location) where each SW component has been deployed from the storage management section, and transmits an instruction for deployment to the device where the SW component has been deployed. The device that has received the instruction for deployment downloads the updated SW component from the container DB of the deployment control module and deploys the updated SW component in processing step PS28. It is to be noted that the AI application described herein is an SW component other than the AI model.

In addition, in a case where both the AI model and the AI application are to operate on one device, both the AI model and the AI application may be collectively updated as one container. In this case, updating of the AI model and updating of the AI application may be performed not sequentially but simultaneously. Such updating is implementable by executing respective pieces of processing in processing steps PS25, PS26, PS27, and PS28.

For example, in a case where it is possible to deploy a container including both the AI model and the AI application to the image sensor IS of the camera 3, executing respective pieces of processing in processing steps PS25, PS26, PS27, and PS28 makes it possible to update the AI model and AI application.

Relearning of the AI model is performed with use of captured image data captured in a usage environment of the user by performing the processing described above. Accordingly, it is possible to generate an edge-side AI model that is able to output a highly accurate recognition result in the usage environment of the user.

In addition, even in a case where the usage environment of the user is changed such as a case where the layout in a store is changed or a case where the installation location of the camera 3 is changed, it is possible to appropriately perform relearning of the AI model in each case, which makes it possible to maintain recognition accuracy by the AI model without lowering the recognition accuracy. It is to be noted that respective pieces of processing described above may be executed not only upon relearning of the AI model but also upon operating a system in the usage environment of the user for the first time.

### 5. Screen Example of Market Place

Description is given of an example of a screen of a market place to be presented to the user with reference to the drawings.

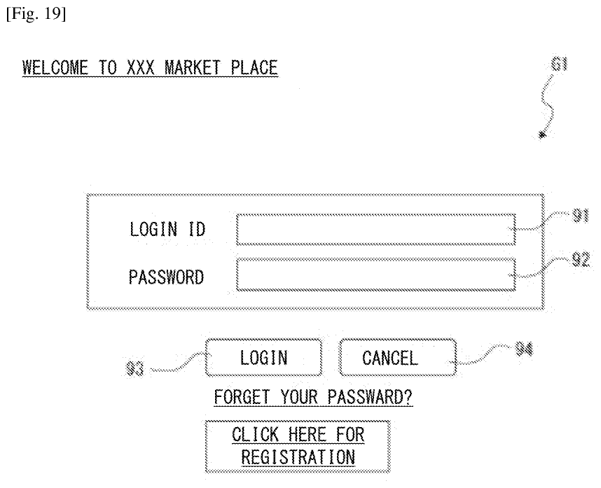

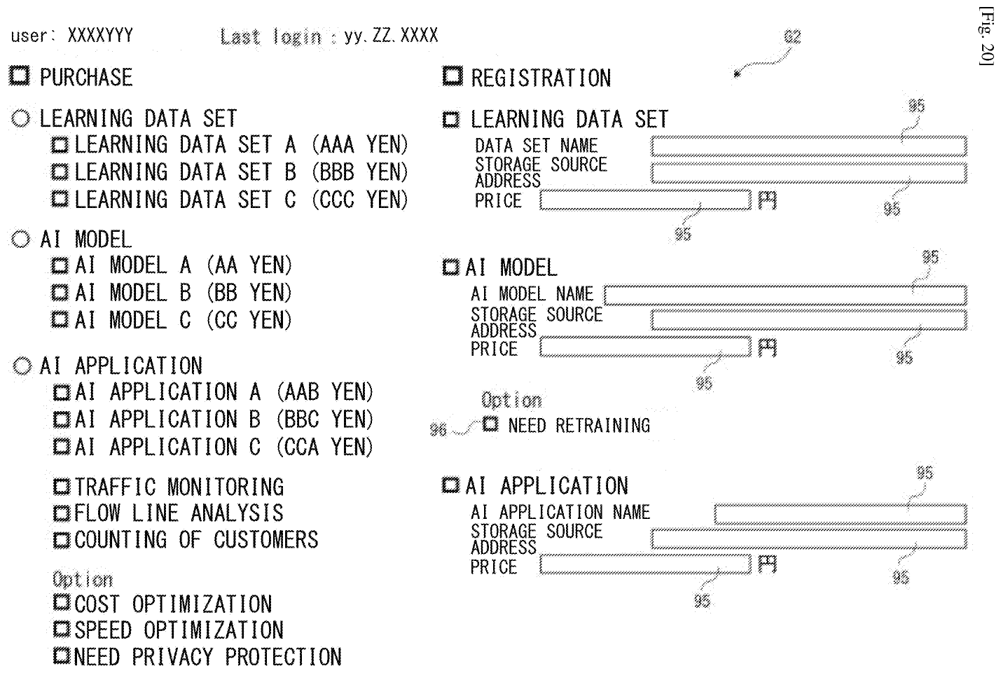

FIG. 19 illustrates an example of a login screen G1. The login screen G1 is provided with an ID input field 91 for inputting a user ID and a password input field 92 for inputting a password.

A login button 93 for performing login and a cancellation button 94 for cancelling the login are disposed below the password input field 92.

In addition, an operator for transition to a page for a user who forgets a password, an operator for transition to a page for performing new user registration, and the like are disposed as appropriate below the login button 93 and the cancellation button 94.

When the login button 93 is pressed after inputting a proper user ID and a proper password, processing for performing transition to a user-specific page is executed in each of the cloud server 1 and the user terminal 2.

FIG. 20 is an example of a screen to be presented to, for example, an AI application developer who uses the application developer terminal 2A or an AI model developer who uses the AI model developer terminal 2C.

Each developer is able to purchase a data set for learning, an AI model, or an AI application for development through a market place. In addition, it is possible to register an AI application or an AI model developed by the developer oneself in the market place.

On a developer screen G2 illustrated in FIG. 20, data sets for learning, AI models, AI applications, and the like that are available for purchase (hereinafter collectively referred to as “data”) are displayed on the left. It is to be noted that although not illustrated, upon purchasing a data set for learning, it is possible to prepare for learning only by displaying an image of the data set for learning on a display, surrounding only a desired portion of the image with a frame with use of an input device such as a mouse, and inputting a name.

For example, in a case where it is desired to perform AI learning with use of an image of a cat, only a cat portion on the image is surrounded with a frame, and “cat” is inputted as a text input, which makes it possible to prepare an image with an annotation of the cat for AI learning. In addition, in order to easily find desired data, a purpose such as “traffic monitoring”, “flow line analysis”, or “counting of customers” may be selectable. In other words, display processing such as displaying only data suitable for the selected purpose is executed in each of the cloud server 1 and the user terminal 2.

It is to be noted that in the developer screen G2, the purchase price of each data may be displayed.

In addition, an input field 95 for registering a data set for learning collected or created by the developer, or an AI model or an AI application developed by the developer is provided on the right in the developer screen G2.

The input field 95 for inputting a name and a data storage location is provided for each data. In addition, a check box 96 for setting need or no need of retraining is provided for the AI model.

It is to be noted that a price setting field (illustrated as the input field 95 in the drawing) may be provided. The price setting field makes it possible to set a price necessary for purchasing data to be registered.

In addition, a user name, the last login date, and the like are displayed as a part of user information in an upper portion of the developer screen G2. It is to be noted that in addition to these, an amount of currency, the number of points that the user is able to use upon purchasing data may be displayed.

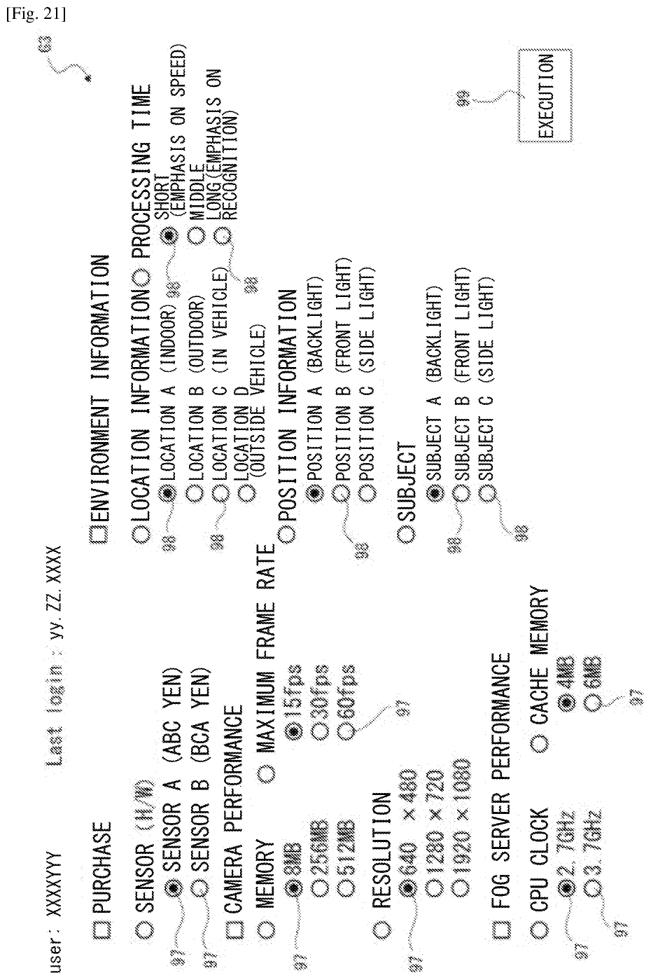

FIG. 21 is an example of a user screen G3 to be presented to a user (the application user described above) who performs various kinds of analysis and the like by deploying the AI application or the AI model to the camera 3 as the edge-side information processing device managed by oneself.

The user is able to purchase, through the market place, the camera 3 that is to be disposed in a space to be monitored. Accordingly, a radio button 97 is disposed on the left in the user screen G3. The radio button 97 makes it possible to select the kind and performance of the image sensor IS to be mounted on the camera 3, and performance of the camera 3, and the like.

In addition, the user is able to purchase an information processing device as the fog server 4 through the market place. Accordingly, the radio button 97 for selecting each performance of the fog server 4 is disposed on the left in the user screen G3. In addition, the user who already has the fog server 4 is able to register the performance of the fog server 4 by inputting performance information of the fog server 4 to the radio button 97.

The user implements a desired function by installing the purchased camera 3 (that may be the camera 3 purchased not through the market place) at any location in a store managed by the user oneself. Meanwhile, in the market place, in order to maximize the function of each camera 3, it is possible to register information about the installation location of the camera 3.

A radio button 98 is provided on the right in the user screen G3. The radio button 98 makes it possible to select environment information about an environment where the camera 3 is installed The user appropriately selects environment information about the environment where the camera 3 is installed to thereby set optimum imaging setting described above for the target camera 3.

It is to be noted that, in a case where the camera 3 is to be purchased and the installation location of the camera 3 to be purchased has been already determined, it is possible to purchase the camera 3 for which optimum imaging setting has been already set in accordance with a planned installation location by selecting respective items on the left and respective items on the right in the user screen G3.

An execution button 99 is provided in the user screen G3. When the execution button 99 is pressed, transition to a confirmation screen for purchase confirmation or a confirmation screen for confirmation of setting of the environment information is performed. Thus, it is possible for the user to purchase the desired camera 3 or the desired fog server 4 and to set the environment information about the camera 3.

In the market place, it is possible to change environment information about each camera 3 in a case where the installation location of the camera 3 is changed. Reinputting environment information about the installation location of the camera 3 on an unillustrated change screen makes it possible to reset optimum imaging setting for the camera 3.

### 6. Summary

As described in the examples above, the cloud-side information processing device (the cloud server 1 or the management server 5) includes a determination processor (the camera service function F5) that determines a target (device) as an execution subject for each SW component in accordance with a user's request about an application (e.g., an AI application) and request specifications of software components (SW components) included in the application.

In other words, a target (such as a deployment destination device) as an execution subject for each software component is determined in consideration of not only performance and the like of the device but also the user's request to the application. Accordingly, the target as the execution subject is determined after excluding not only a device that cannot be the target as the execution subject of the SW component in terms of performance, but also a device that is not suitable for the user's request. Thus, each SW component is deployed so as to allow the application to exhibit appropriate performance in accordance with the user's request.

In addition, it is possible to determine the target as the execution subject by comparing request specifications of the SW component and specifications of a candidate for the target as the execution subject; therefore, it is not necessary to construct a simulation environment for executing the application and perform a preliminary simulation, and it is possible to achieve reduction in a processing load and reduction in time until finishing deployment.

It is to be noted that, in addition to the examples described above, various examples including “grasping and analysis of behaviors of consumers”, “missing item detection”, “counting of the number of users”, “prediction of the number of users”, “user tracking”, “congestion detection”, “congestion analysis”, “danger sensing”, “bar code reading”, “detection of an intruder into a dangerous area”, “detection of an improper hazardous material handling method”, “helmet/mask wearing detection”, “counting of passersby”, and “line detection” are considered as the application to be selected by the user.

As described above, the application includes a plurality of software components (SW components), and a plurality of targets may be determined as the targets as the execution subjects for the plurality of software components. This prevents the plurality of SW components that implements the application from being deployed to one device.

Accordingly, it is possible to implement the application by distribution processing in a plurality of devices, which makes it possible to reduce the processing load of each of the devices. In addition, the SW components are distributed and deployed, which makes it possible to reduce an influence caused by occurrence of a fault in the device and to enhance fault tolerance.

An information processing method according to the present technology includes causing a computer device to execute processing for determining a target as an execution subject for each of software components included in an application in accordance with a user's request about the application and request specifications of the software components.

It is possible to record, in advance, a program to be executed by the information processing device (the cloud server 1 or the management server 5) described above in an HDD (Hard Disk Drive) as a recording medium built in a device such as a computer device or a ROM or the like in a microcomputer including a CPU. Alternatively, the program may be temporarily or permanently stored (recorded) in a removable recording medium such as a flexible disk, a CD-ROM (Compact Disk Read Only Memory), an MO (Magneto Optical) disk, a DVD (Digital Versatile Disc), a Blu-ray Disc (registered trademark), a magnetic disk, a semiconductor memory, or a memory card. It is possible to provide such a removable recording medium as so-called package software.

In addition, it is possible not only to install such a program from the removable recording medium into a personal computer or the like, but also to download such a program from a download site through a network such as a LAN (Local Area Network) or the Internet.

The schematic configuration example of the information processing system 600 to which the technology according to the present disclosure may be applied has be described above. The technology according to the present disclosure may be applied to the camera 3 among components described above. Specifically, the camera 3 of the information processing system 600 may be replaced with the anonymization surveillance camera 100, or the camera 3 and the anonymization surveillance camera 100 may coexist in the information processing system 600.

In addition, the technology according to the present disclosure may be applied by providing the feature amount converter 150, the mask processor 160, or the like as a function of the anonymization surveillance camera 100 to the camera 3 of the information processing system 600. In this case, as one example, functions of the feature amount converter 150 and the mask processor 160 may be provided to the image signal processor 42 in FIG. 13, and a mask image Ib outputted from the mask processor 160 may be transmitted from the communication I/F to outside such as the cloud server 1 or the fog server 4 through the communication section 35.

In addition, the function of the information processing device 300 described in FIG. 4 may be provided to the cloud server 1 or the fog server 4. As one example, the technology according to the present disclosure is applicable by causing the input section 76 and the communication section 80 in FIG. 17 to correspond to the image receiver 310 and the output section 340 in FIG. 4 and implementing the subject recognition section 320 and the decoding section 330 in FIG. 4 with use of the CPU 71, the ROM 72, the RAM 73, the storage section 79, or the like in FIG. 17.

Applying the technology according to the present disclosure to the camera 3 of the information processing system 600 as described above makes it possible to make it difficult to specify information for identifying a subject even in such an information processing system 600.

### 7. Application Example

The technology according to the present disclosure (the present technology) is applicable to various products. For example, the technology according to the present disclosure may be implemented as a device to be mounted on any type of mobile body such as an automobile, an electric vehicle, a hybrid electric vehicle, a motorcycle, a bicycle, a personal mobility, an airplane, a drone, a vessel, or a robot.

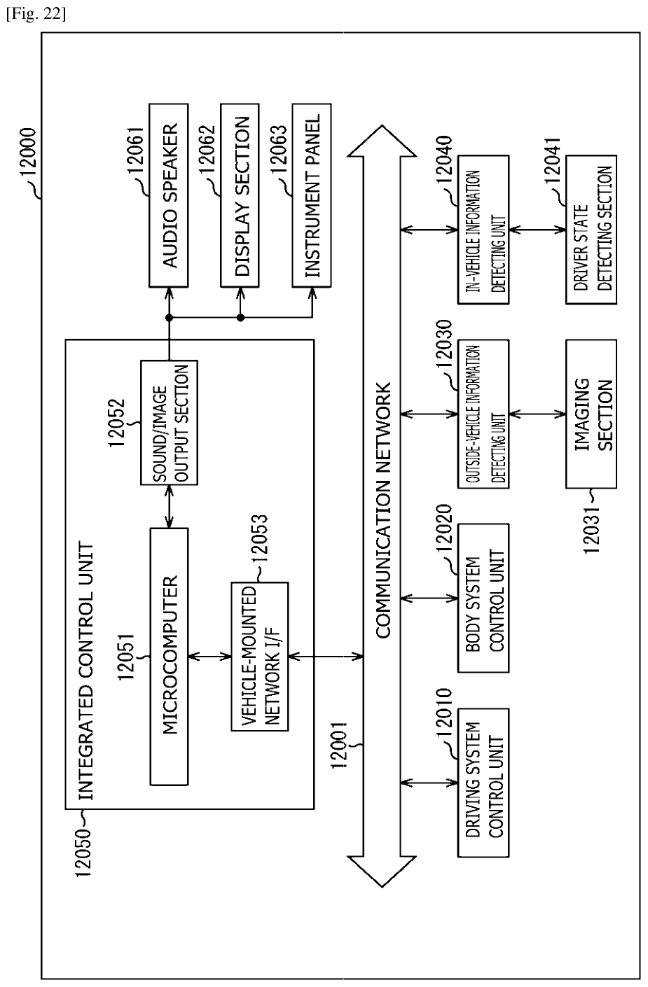

FIG. 22 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 22, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing for detecting an object such as a human, a vehicle, an obstacle, a sign, a character on a road surface, or the like, or processing for detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 22, an audio speaker 12061, a display section 12062, and an instrument panel 12063 are illustrated as the output device. The display section 12062 may, for example, include at least one of an on-board display and a head-up display.

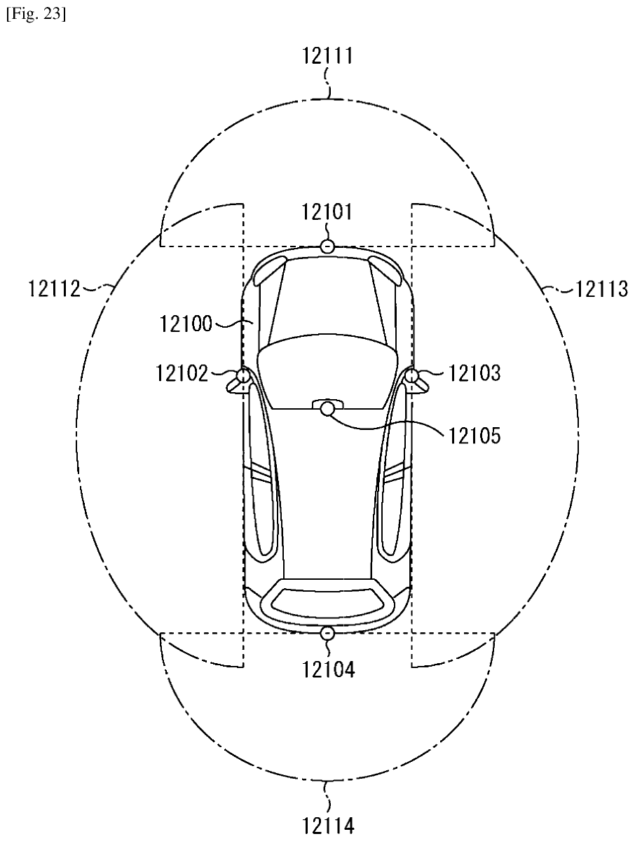

FIG. 23 is a diagram depicting an example of the installation position of the imaging section 12031.

In FIG. 23, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 23 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

One example of the vehicle control system to which the technology according to the present disclosure may be applied has been described above. The technology according to the present disclosure may be applied to a camera provided in the imaging section 12031 or the driver state detecting section 12041 among the components described above.

As one example, in a case where the technology according to the present disclosure is applied to the camera provided in the driver state detecting section 12041, the camera captures an image of a subject such as a driver or an occupant in a vehicle, and it is possible to make it difficult to specify information for identifying the subject, and to transmit the information to the information processing device 300 outside the vehicle through a communication section or a network. In addition, it is possible to specify the driver or the occupant in the vehicle from outside the vehicle by receiving the information for identifying the subject that has been made difficult to be specified outside the vehicle.

As another example, in a case where the technology according to the present disclosure is applied to the imaging section 12031, the imaging section 12031 captures an image of a subject such as a person outside the vehicle, and it is possible to make it difficult to specify information for identifying the subject, and to transmit the information to the information processing device 300 outside the vehicle through a communication section or a network. In addition, it is possible to specify the person from outside the vehicle by receiving the information for identifying the subject that has been made difficult to be specified outside the vehicle.

Applying the technology according to the present disclosure to the camera provided in the imaging section 12031 or the driver state detecting section 12041 as described above makes it possible to make it difficult to specify the information for identifying the subject even in such a vehicle control system.

It is to be noted that the effects described herein are merely illustrative. The effects of the present disclosure is not limited to the effects described herein. The present disclosure may have effects other than the effects described herein. In addition, examples have been separately described herein, but these examples may be combined.

In addition, the present disclosure may have the following configurations.

(1)

An image processing device including:
circuitry configured to
recognize and extract an object included in a captured image;
convert, using an artificial intelligence (AI) model, a region image including the object to generate a feature image;
generate a mask image by combining the captured image with the feature image; and output the mask image.
   (2)

The image processing device according to (1), in which, to generate the feature image, the circuitry is further configured to project the region image to a feature space and dimensionally compress feature data obtained by projection of the region image to the feature space.

(3)

The image processing device according to (2), in which the AI model includes a first AI model obtained by performing learning on the first AI model and a second AI model to cause an output image to approximate to an input image, the first AI model being used to generate the feature image by converting the input image, and the second AI model being used to generate the output image by converting the feature image generated using the first AI model.

(4)

The image processing device according to any one of (1) to (3), in which the feature image includes an image including an object that cannot be visually identified.

(5)

The image processing device according to any one of (1) to (4), in which the circuitry is further configured to perform processing to ease imaging environment dependence of the captured image, and
the circuitry recognizes and extracts the object included in an image obtained from the processing to ease the imaging environment dependence.
   (6)

The image processing device according to (5), in which the AI model is obtained by learning a master image obtained in a specific imaging environment as an input image.

(7)

An image processing method including:
recognizing and extracting an object included in a captured image;
converting, using an artificial intelligence (AI) model, a region image including the object to generate a feature image;
generating a mask image by combining the captured image with the generated feature image; and
outputting the mask image.
   (8)

A non-transitory computer-readable recording medium storing a program that, when executed by a computer, causes the computer to perform a method comprising:
recognizing and extracting an object included in a captured image;
converting, using an artificial intelligence (AI) model, a region image including the object to generate a feature image;
generating a mask image by combining the captured image with the generated feature image; and
outputting the mask image.
   (9)

The image processing device according to (5) or (6), in which the processing to ease imaging environment dependence includes demosaicing and gamma correction.

(10)

The image processing device according to any one of (1) to (6) or (9), in which the circuitry combines the captured image with the feature image by superposition.

(11)

The image processing device according to any one of (1) to (6) or (9) to (10), in which the object cannot be identified from the feature image.

(12)

The image processing device according to anyone of (1) to (6) or (9) to (11), in which the image processing device is a surveillance camera.

(13)

The image processing device according to any one of (3) to (6) or (9) to (12), in which the second AI model is a multi-layer perceptron (MLP).

(14)

The image processing device according to (13), in which the MLP includes variable weights.

(15)

The image processing device according to (14), in which the MLP is a classification feedforward network including at least three node layers.

(16)

The image processing device according to (15), in which the circuitry is further configured to use supervised training to train the MLP for object recognition, and to periodically transmit the MLP to another device via a network.

(17)

The image processing device according to (16), in which the circuitry is further configured to, upon receipt of an instruction from the other device, perform retraining of the MLP.

(18)

The image processing device according to (12), further comprising an image sensor to capture the captured image.

(19)

The image processing device according to (18), in which the image sensor is one of a charged coupled device (CCD) and a CMOS sensor.

(20)

The image processing device according to any one of (3) to (6) or (9) to (19), wherein the first AI model and the second AI model together form an autoencoder.

In an image processing device according to a first aspect of the present disclosure, an image processing method according to a second aspect of the present disclosure, and a recording medium according to a third aspect of the present disclosure, a feature amount image is generated by encoding a region image including a subject extracted from a captured image, and a mask image is generated by combining the captured image and the feature amount image with each other. Herein, the feature amount image included in the mask image is meaningless as information for identifying the subject. Accordingly, it is not possible to obtain information for identifying the subject from the mask image, which makes it possible to prevent the information for identifying the subject from being leaked to outside even in a case where the mask image is provided to outside. In addition, M-dimensional feature amount data obtained by decoding the feature amount image by a publicly known decoder has a feature specific to the subject. Accordingly, it is possible to identify the subject by analyzing the M-dimensional feature amount data obtained from the feature amount image. Thus, it is possible to perform processing for making it difficult to specify the information for identifying the subject without impairing a subject recognition function.

It should be understood by those skilled in the art that various modifications, combinations, sub-combinations, and alterations may occur depending on design requirements and other factors insofar as they are within the scope of the appended claims or the equivalents thereof.

### REFERENCE SIGNS LIST

100: anonymization surveillance camera
110: lens
120: imaging section
130: development section
140: subject recognition section
150: feature amount converter
160: mask processor
170: output section
181, 181_1, 181_2, 181_i, 181_M, 184: subject recognition AI
182: MLP
183: communication section
191: image processor
192: storage section
192a: image processing program
200: AI model
210: encoder
220: decoder
300: information processing device
310: image receiver
320: subject recognition section
330: decoding section
340: output section
400: information processing device
410: communication section
420: storage section
430: controller
500: network

1. An image processing device comprising:
circuitry configured to
recognize and extract an object included in a captured image;
convert, based on an artificial intelligence (AI) model, a region image including the object to generate a feature image;
generate a mask image by combining the captured image with the feature image; and
output the mask image.

2. The image processing device according to claim 1, wherein, to generate the feature image, the circuitry is further configured to project the region image to a feature space and dimensionally compress feature data obtained by projection of the region image to the feature space.

3. The image processing device according to claim 2, wherein the AI model includes a first AI model obtained by performing learning on the first AI model and a second AI model to cause an output image to approximate to an input image, the first AI model being used to generate the feature image by converting the input image, and the second AI model being used to generate the output image by converting the feature image generated using the first AI model.

4. The image processing device according to claim 1, wherein the feature image comprises an image including an object that cannot be visually identified.

5. The image processing device according to claim 1, wherein the circuitry is further configured to perform processing to ease imaging environment dependence of the captured image, and
the circuitry recognizes and extracts the object included in an image obtained from the processing to ease the imaging environment dependence.

6. The image processing device according to claim 5, wherein the AI model is obtained by learning a master image obtained in a specific imaging environment as an input image.

7. An image processing method comprising:
recognizing and extracting an object included in a captured image;
converting, using an artificial intelligence (AI) model, a region image including the object to generate a feature image;
generating a mask image by combining the captured image with the generated feature image; and
outputting the mask image.

8. A non-transitory computer-readable recording medium storing a program that, when executed by a computer, causes the computer to perform a method comprising:
recognizing and extracting an object included in a captured image;
converting, using an artificial intelligence (AI) model, a region image including the object to generate a feature image;
generating a mask image by combining the captured image with the generated feature image; and
outputting the mask image.

9. The image processing device according to claim 5, wherein the processing to ease imaging environment dependence includes demosaicing and gamma correction.

10. The image processing device according to claim 1, wherein the circuitry combines the captured image with the feature image by superposition.

11. The image processing device according to claim 1, wherein the object cannot be identified from the feature image.

12. The image processing device according to claim 1, wherein the image processing device is a surveillance camera.

13. The image processing device according to claim 3, wherein the second AI model is a multi-layer perceptron (MLP).

14. The image processing device according to claim 13, wherein the MLP includes variable weights.

15. The image processing device according to claim 14, wherein the MLP is a classification feedforward network including at least three node layers.

16. The image processing device according to claim 15, wherein the circuitry is further configured to use supervised training to train the MLP for object recognition, and to periodically transmit the MLP to another device via a network.

17. The image processing device according to claim 16, wherein the circuitry is further configured to, upon receipt of an instruction from the other device, perform retraining of the MLP.

18. The image processing device according to claim 12, further comprising an image sensor to capture the captured image.

19. The image processing device according to claim 18, wherein the image sensor is one of a charged coupled device (CCD) and a CMOS sensor.

20. The image processing device according to claim 3, wherein the first AI model and the second AI model together form an autoencoder.
